(19) United States
(12) Patent Application Publication
(10) Pub. No.: US 2026/0253414 A1
(43) Pub. Date: Aug. 27, 2026

(54) SYSTEM

(71) Applicant: SoftBank Group Corp., Tokyo (JP)

(72) Inventor: Mihoko NAKANO, Tokyo (JP)

(73) Assignee: SoftBank Group Corp., Tokyo (JP)

(21) Appl. No.: 19/531,683

(22) Filed: Feb. 6, 2026

(30) Foreign Application Priority Data
Feb. 21, 2025 (JP) 2025-027055

(51) Int. Cl. G06V 20/30; G06F 16/435; G06V 10/74; G06V 10/762; G06V 10/764; G06V 10/82; G06V 10/98; G06V 40/16; G10L 25/63; G11B 27/036

(52) U.S. Cl. CPC G06V 20/30; G06F 16/435; G06V 10/761; G06V 10/762; G06V 10/764; G06V 10/82; G06V 10/993; G06V 40/172; G06V 40/178; G11B 27/036; G06V 40/174; G10L 25/63

(57) ABSTRACT

The system according to the embodiment comprises a receiving unit, a detection unit, an extraction unit, an editing unit, a registration unit, and a search unit. The receiving unit inputs photo or video data. The detection unit detects duplicate photos or erroneous photos from the data input by the receiving unit. The extraction unit extracts photos from the data detected by the detection unit. The editing unit edits a video based on the data extracted by the extraction unit. The registration unit registers faces of family members. The search unit searches for desired photos or videos based on the face data registered by the registration unit.

### CROSS-REFERENCE TO RELATED APPLICATION

The present application claims priority to and incorporates by reference the entire contents of Japanese Patent Application No. 2025-027055 filed in Japan on Feb. 21, 2025.

### BACKGROUND OF THE INVENTION

### 1. Field of the Invention

The technology of this disclosure relates to a system.

### 2. Description of the Related Art

Japanese Patent Application Laid-open No. 2022-180282 discloses a persona chatbot control method executed by at least one processor, comprising: receiving a user utterance, adding the user utterance to a prompt containing instructions related to the character of the chatbot, encoding the prompt, inputting the encoded prompt into a language model, and generating a chatbot utterance in response to the user utterance.

In conventional technology, there has been a problem that the task of manually eliminating duplicate photos or erroneous photos from accumulated photo or video data and selecting good photos is complicated.

### SUMMARY OF THE INVENTION

The system according to the embodiment comprises a receiving unit, a detection unit, an extraction unit, an editing unit, a registration unit, and a search unit. The receiving unit inputs photo or video data. The detection unit detects duplicate photos or erroneous photos from the data input by the receiving unit. The extraction unit extracts photos from the data detected by the detection unit. The editing unit edits a video based on the data extracted by the extraction unit. The registration unit registers faces of family members. The search unit searches for desired photos or videos based on the face data registered by the registration unit.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a conceptual diagram showing an example configuration of a data processing system according to the first embodiment;

FIG. 2 is a conceptual diagram showing an example of main functions of a data processing device and a smart device according to the first embodiment;

FIG. 3 is a conceptual diagram showing an example configuration of a data processing system according to the second embodiment;

FIG. 4 is a conceptual diagram showing an example of main functions of a data processing device and smart glasses according to the second embodiment;

FIG. 5 is a conceptual diagram showing an example configuration of a data processing system according to the third embodiment;

FIG. 6 is a conceptual diagram showing an example of main functions of a data processing device and a headset-type terminal according to the third embodiment;

FIG. 7 is a conceptual diagram showing an example configuration of a data processing system according to the fourth embodiment;

FIG. 8 is a conceptual diagram showing an example of main functions of a data processing device and a robot according to the fourth embodiment;

FIG. 9 shows an emotion map where multiple emotions are mapped; and

FIG. 10 shows an emotion map where multiple emotions are mapped.

### DETAILED DESCRIPTION OF THE PREFERRED EMBODIMENTS

Hereinafter, an example of an embodiment of the system related to the technology disclosed herein will be described with reference to the attached drawings.

First, the terminology used in the following description will be explained.

In the following embodiments, a processor denoted by a reference numeral (hereinafter simply referred to as “processor”) may be a single computing device or a combination of multiple computing devices. The processor may be a single type of computing device or a combination of multiple types of computing devices. Examples of computing devices include a CPU (Central Processing Unit), GPU (Graphics Processing Unit), GPGPU (General-Purpose computing on Graphics Processing Units), APU (Accelerated Processing Unit), or TPU (Tensor Processing Unit), among others.

In the following embodiments, a RAM (Random Access Memory) denoted by a reference numeral is a memory where information is temporarily stored and used as a work memory by the processor.

In the following embodiments, a storage denoted by a reference numeral is one or more non-volatile storage devices for storing various programs and parameters. Examples of non-volatile storage devices include flash memory (SSD (Solid State Drive)), magnetic disks (e.g., hard disks), or magnetic tapes, among others.

In the following embodiments, a communication I/F (Interface) denoted by a reference numeral is an interface including a communication processor and an antenna, among others. The communication I/F manages communication between multiple computers. Examples of communication standards applicable to the communication I/F include wireless communication standards such as 5G (5th Generation Mobile Communication System), Wi-Fi (registered trademark), or Bluetooth (registered trademark), among others.

In the following embodiments, “A and/or B” means “at least one of A and B.” In other words, “A and/or B” means it may be only A, only B, or a combination of A and B. Moreover, when expressing three or more items connected by “and/or,” the same concept as “A and/or B” applies.

### First Embodiment

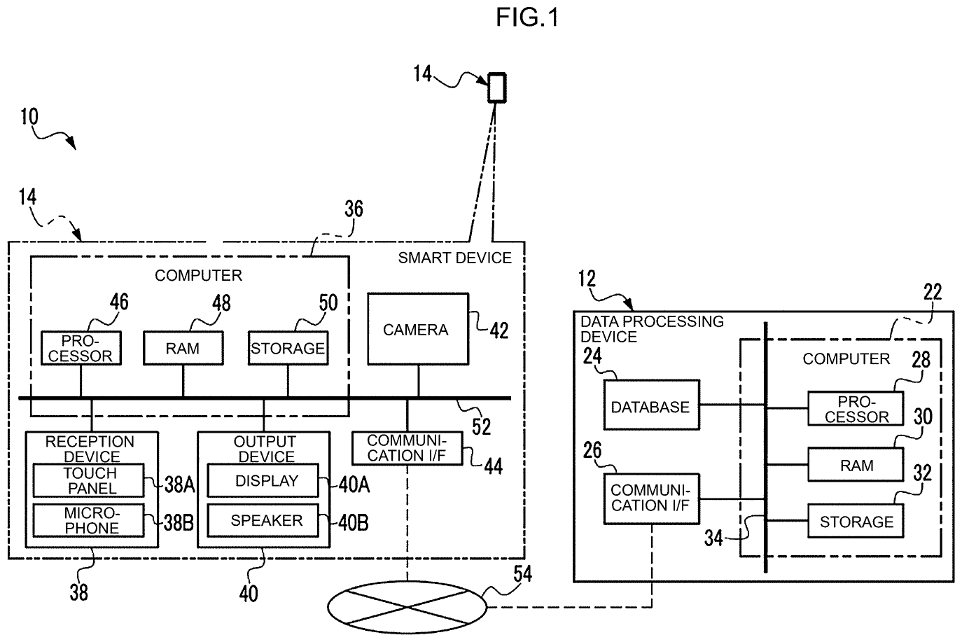

FIG. 1 shows an example configuration of a data processing system 10 according to the first embodiment.

As shown in FIG. 1, the data processing system 10 comprises a data processing device 12 and a smart device 14. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The smart device 14 comprises a computer 36, a reception device 38, an output device 40, a camera 42, and a communication I/F 44. The computer 36 comprises a processor 46, RAM 48, and storage 50. The processor 46, RAM 48, and storage 50 are connected to a bus 52. The reception device 38, output device 40, and camera 42 are also connected to the bus 52.

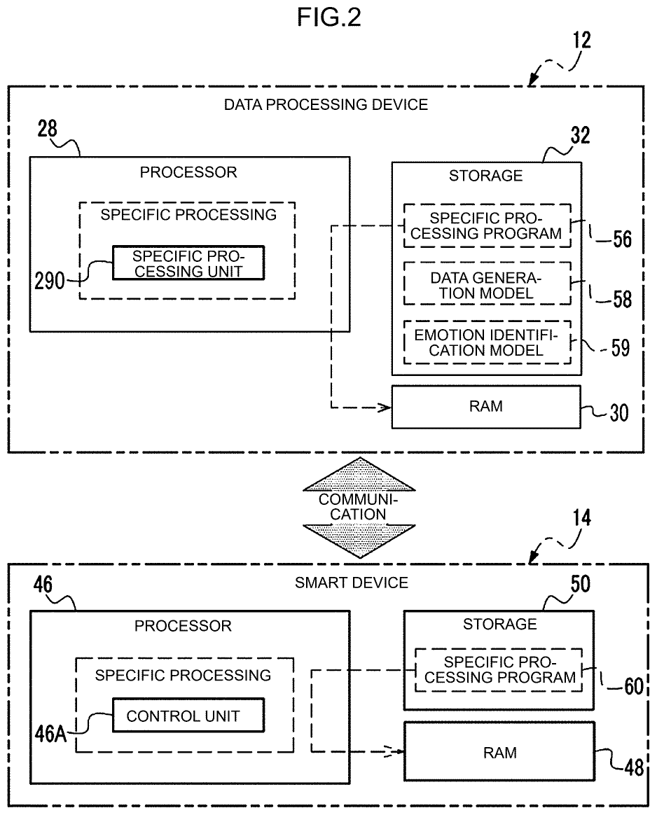

The reception device 38 comprises a touch panel 38A and a microphone 38B, among others, and accepts user input. The touch panel 38A accepts user input by detecting contact from an indicating object (e.g., a pen or finger). The microphone 38B accepts user input by detecting the user's voice. The control unit 46A sends data indicating user input accepted by the touch panel 38A and microphone 38B to the data processing device 12. The data processing device 12 has a specific processing unit 290 (see FIG. 2) that acquires data indicating user input.

The output device 40 comprises a display 40A and a speaker 40B, among others, and presents data to the user by outputting it in a perceptible form (e.g., audio and/or text). The display 40A displays visible information such as text and images according to instructions from the processor 46. The speaker 40B outputs audio according to instructions from the processor 46. The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors.

The communication I/F 44 is connected to the network 54. The communication I/F 44 and 26 manage the exchange of various information between the processor 46 and the processor 28 via the network 54.

FIG. 2 shows an example of the main functions of the data processing device 12 and the smart device 14.

As shown in FIG. 2, specific processing is performed in the data processing device 12 by the processor 28. The storage 32 stores a specific processing program 56. The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the smart device 14, specific processing is performed by the processor 46. The storage 50 stores a specific processing program 60. The specific processing program 60 is used in conjunction with the specific processing program 56 by the data processing system 10. The processor 46 reads the specific processing program 60 from the storage 50 and executes it on the RAM 48. The specific processing is realized by the processor 46 operating as a control unit 46A according to the specific processing program 60 executed on the RAM 48. The smart device 14 may also have similar data generation models and emotion identification models as the data generation model 58 and emotion identification model 59, and perform the same processing as the specific processing unit 290 using these models.

Other devices besides the data processing device 12 may have the data generation model 58. For example, a server device (e.g., a generation server) may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.). Next, an example of processing by the data processing system 10 according to the first embodiment will be described.

### Example of the Embodiment

The photo and video management system according to the embodiment of the present invention is a system that efficiently manages accumulated photo and video data, enabling users to easily obtain “good” photos and videos. This system comprises: a receiving unit configured to input photo or video data; a detection unit configured to detect duplicate photos or erroneous photos from the data input by the receiving unit; an extraction unit configured to extract good photos from the data detected by the detection unit; an editing unit configured to edit a video based on the data extracted by the extraction unit; a registration unit configured to register faces of family members; and a search unit configured to search for desired photos or videos based on the face data registered by the registration unit. For example, when a user inputs accumulated photo or video data into the system, the system automatically detects and eliminates duplicate photos and erroneous photos such as backlit photos. For instance, if the same scene is photographed multiple times, the system selects the best photo and eliminates other duplicate photos. Additionally, photos in which faces are dark due to backlighting or are out-of-focus are also eliminated. Next, the system extracts “good” photos from the remaining photo and video data. For example, it selects photos in which faces are clearly shown or photos with good composition. This allows users to easily obtain only “good” photos. Furthermore, based on the duration or image specified by the user, the system automatically combines videos or photos to edit a video. For example, if the user specifies “create a 3-minute travel video,” the system automatically combines photos and videos taken during the trip to edit a 3-minute video. If the user specifies “create a video with an emotional atmosphere,” the system adds emotional music and effects to create a video with an emotional atmosphere. Moreover, by registering faces of family members, users can always view desired photos or videos, such as “show me photos of XX at age 5” or “edit videos of XX during junior high school.” For example, if the user instructs “show me photos of XX at age 5,” the system automatically searches for and displays photos taken of XX at age 5 based on the registered face data. If the user instructs “edit videos of XX during junior high school,” the system automatically combines photos and videos taken during junior high school to edit a video. Thus, the photo and video management system efficiently manages accumulated photo and video data, enabling users to easily obtain “good” photos and videos. Specifically, this photo and video management system operates by linking multiple computer modules: receiving unit, detection unit, extraction unit, editing unit, registration unit, and search unit. The receiving unit receives image files such as JPEG and PNG, and video files such as MP4 and AVI from user terminals or external storage, and stores them in internal memory as high-dimensional tensors (e.g., 3D RGB tensor for images, 4D spatiotemporal tensor for videos). The detection unit uses image classification models equipped with convolutional neural networks (CNN) and self-attention mechanisms to calculate duplicate scores (e.g., cosine similarity or feature vector distance) and erroneous photo scores (e.g., backlight degree, out-of-focus degree, brightness histogram of face regions) for the input tensors. For example, when multiple images of the same scene are input, the detection unit extracts feature vectors (e.g., 512 dimensions) for each image, groups them using clustering algorithms (such as K-means), and retains only the image with the highest quality score within each group. For erroneous photo detection, a face detection model (e.g., YOLO-based) extracts face regions, quantifies backlight and out-of-focus using brightness distribution and edge information, and eliminates them by threshold judgment. The extraction unit uses face recognition models (ResNet-based or Transformer-based) to calculate clarity and expression scores for face regions, and composition evaluation models (e.g., rule-of-thirds score, subject centering, color balance) to synthesize multiple evaluation indices with weights to generate a “good photo” score. For example, whether a face is clearly shown is quantified by edge strength, noise amount, and landmark detection accuracy for eyes and mouth in the face region. The editing unit receives user-specified video length (e.g., 180 seconds) and theme (e.g., emotional, fun) in natural language, vectorizes it using a text encoder (large language model), and combines it with metadata of photos and videos obtained from the extraction unit to determine the optimal sequence. The video editing AI automatically applies transition effects (e.g., fade, slide), selects BGM (e.g., piano music for emotional videos), and effects (color correction, slow motion), and generates the final video file. The registration unit extracts face feature vectors (e.g., 128 dimensions) from family member face photos uploaded by the user, estimates age (using age estimation CNN), and registers face ID and age estimation in a database. The search unit vectorizes the user's natural language query (e.g., “photos of XX at age 5”) using a text encoder, combines it with face ID, age, and shooting date metadata, and performs fast index search (e.g., approximate nearest neighbor search using Annoy or FAISS) to display relevant photos or videos as thumbnails. Examples of AI input include image tensors (e.g., 224×224×3), video tensors (e.g., 64 frames×224×224×3), face photos (e.g., 128×128×3), which are input to CNNs or Transformers in the detection and extraction units. Examples of AI output include duplicate scores (e.g., 0.95), erroneous photo labels (1: backlit, 0: normal), good photo scores (e.g., 0.87), face ID (integer), age estimation (e.g., 5 years old), and search result lists (photo ID arrays). These scores and labels are used for subsequent threshold judgment, ranking, video editing sequence generation, and display order control of search results. As a technical effect, this system achieves significant improvements in accuracy, speed, and reduction of user burden compared to conventional systems by enabling automatic judgment in high-dimensional feature space of images and videos, and multidimensional matching of natural language queries with face data and metadata, without relying on human subjective judgment. Application fields include family album management, school event records, corporate event records, customer photo services in the tourism industry, and automatic album generation linked with SNS.

The photo and video management system according to the embodiment comprises a receiving unit, a detection unit, an extraction unit, an editing unit, a registration unit, and a search unit. The receiving unit inputs photo or video data. Photo or video data may include formats such as JPEG, PNG, MP4, AVI, but is not limited thereto. The receiving unit, for example, allows users to upload photos or video data they have taken to the system. The receiving unit can also import data from external devices, such as receiving data via USB connection or Wi-Fi. The detection unit detects duplicate photos or erroneous photos from the data input by the receiving unit. Duplicate photos or erroneous photos may include identical image files, highly similar images, backlit photos, out-of-focus photos, but are not limited thereto. The detection unit, for example, uses deep learning or computer vision technology to detect duplicate photos or erroneous photos. For instance, when the same scene is photographed multiple times, the detection unit selects the best photo and eliminates other duplicate photos. Additionally, photos in which faces are dark due to backlighting or are out-of-focus are also eliminated. The extraction unit extracts good photos from the data detected by the detection unit. Good photos may include photos in which faces are clearly shown or photos with good composition, but are not limited thereto. The extraction unit, for example, uses face recognition technology to extract photos in which faces are clearly shown. The extraction unit can also extract photos based on composition and image quality. For example, the extraction unit uses Haar-like features or deep learning-based face recognition technology to extract photos in which faces are clearly shown. The editing unit edits a video based on the data extracted by the extraction unit. Editing may include video length, effects used, transitions, but is not limited thereto. The editing unit, for example, combines videos or photos to edit a video based on the duration or image specified by the user. For instance, if the user specifies “create a 3-minute travel video,” the editing unit automatically combines photos and videos taken during the trip to edit a 3-minute video. If the user specifies “create a video with an emotional atmosphere,” the editing unit adds emotional music and effects to create a video with an emotional atmosphere. The registration unit registers faces of family members. Registration may include recognizing family member face photos uploaded by the user and registering them in a database, but is not limited thereto. The registration unit, for example, uses face recognition technology to recognize family member face photos and register them in a database. The search unit searches for desired photos or videos based on the face data registered by the registration unit. Searching may include search algorithms based on face data and display methods for search results, but is not limited thereto. The search unit, for example, quickly searches for and displays desired photos or videos based on the registered face data. Thus, the photo and video management system according to the embodiment efficiently manages accumulated photo or video data, enabling users to easily obtain “good” photos or videos. Specifically, this photo and video management system operates by linking multiple computer modules: receiving unit, detection unit, extraction unit, editing unit, registration unit, and search unit. The receiving unit receives image files such as JPEG and PNG, and video files such as MP4 and AVI from user terminals or external storage, and stores them in internal memory as high-dimensional tensors (3D RGB tensor for images, 4D spatiotemporal tensor for videos). The detection unit uses image classification models equipped with convolutional neural networks and self-attention mechanisms to calculate duplicate scores (cosine similarity or feature vector distance) and erroneous photo scores (backlight degree, out-of-focus degree, brightness histogram of face regions) for the input tensors. For example, when multiple images of the same scene are input, the detection unit extracts feature vectors (e.g., 512 dimensions) for each image, groups them using clustering algorithms (such as K-means), and retains only the image with the highest quality score within each group. For erroneous photo detection, a face detection model (YOLO-based) extracts face regions, quantifies backlight and out-of-focus using brightness distribution and edge information, and eliminates them by threshold judgment. The extraction unit uses face recognition models (ResNet-based or Transformer-based) to calculate clarity and expression scores for face regions, and composition evaluation models (rule-of-thirds score, subject centering, color balance) to synthesize multiple evaluation indices with weights to generate a “good photo” score. For example, whether a face is clearly shown is quantified by edge strength, noise amount, and landmark detection accuracy for eyes and mouth in the face region. The editing unit receives user-specified video length (e.g., 180 seconds) and theme (e.g., emotional, fun) in natural language, vectorizes it using a text encoder (large language model), and combines it with metadata of photos and videos obtained from the extraction unit to determine the optimal sequence. The video editing AI automatically applies transition effects (fade, slide), selects BGM (e.g., piano music for emotional videos), and effects (color correction, slow motion), and generates the final video file. The registration unit extracts face feature vectors (e.g., 128 dimensions) from family member face photos uploaded by the user, estimates age (using age estimation CNN), and registers face ID and age estimation in a database. The search unit vectorizes the user's natural language query (e.g., “photos of XX at age 5”) using a text encoder, combines it with face ID, age, and shooting date metadata, and performs fast index search (approximate nearest neighbor search using Annoy or FAISS) to display relevant photos or videos as thumbnails. Examples of AI input include image tensors (224×224×3), video tensors (64 frames×224×224×3), face photos (128×128×3), which are input to CNNs or Transformers in the detection and extraction units. Examples of AI output include duplicate scores (0.95), erroneous photo labels (1: backlit, 0: normal), good photo scores (0.87), face ID (integer), age estimation (5 years old), and search result lists (photo ID arrays). These scores and labels are used for subsequent threshold judgment, ranking, video editing sequence generation, and display order control of search results. As a technical effect, this system achieves significant improvements in accuracy, speed, and reduction of user burden compared to conventional systems by enabling automatic judgment in high-dimensional feature space of images and videos, and multidimensional matching of natural language queries with face data and metadata, without relying on human subjective judgment. Application fields include family album management, school event records, corporate event records, customer photo services in the tourism industry, and automatic album generation linked with SNS.

The detection unit can detect duplicate photos or erroneous photos such as backlit or out-of-focus photos using image recognition technology. Image recognition technology may include, for example, deep learning or computer vision technology, but is not limited thereto. The detection unit, for example, uses deep learning to detect duplicate photos. For instance, when the same scene is photographed multiple times, the deep learning model selects the best photo and eliminates other duplicate photos. Additionally, the detection unit can use computer vision technology to detect erroneous photos such as backlit or out-of-focus photos. For example, it automatically detects and eliminates photos in which faces are dark due to backlighting or are out-of-focus. By using image recognition technology, the detection accuracy for duplicate photos or erroneous photos is improved. Some or all of the above-described processing in the detection unit may be performed using AI or without using AI. For example, the detection unit can use an AI model for detecting duplicate photos or erroneous photos to perform detection. Specifically, the detection unit processes image tensors received from the receiving unit (e.g., 224×224×3 RGB images, or 64 frames×224×224×3 spatiotemporal tensors for videos) using image classification models equipped with convolutional neural networks and self-attention mechanisms. The detection unit extracts feature vectors of 512 dimensions or more from each image or video frame, calculates cosine similarity or Euclidean distance between these vectors, and computes duplicate scores (e.g., 0.98). For example, when multiple images of the same scene are input, the detection unit applies K-means clustering or hierarchical clustering, calculates quality scores (e.g., sharpness, brightness of face regions, noise amount) within each group, and retains only the best image. For erroneous photo judgment, a YOLO-based face detection model extracts face regions, quantifies brightness histogram, edge strength, and blur degree (e.g., Laplacian variance) in the face region, and scores backlight degree and out-of-focus degree. For example, if the backlight degree is 0.7 or higher, or the out-of-focus degree is 0.5 or higher, an erroneous photo label (1) is assigned; normal images are assigned 0. Examples of AI output include duplicate scores (0.95), erroneous photo labels (1: backlit, 0: normal), quality scores (0.87), which are used for subsequent threshold judgment, ranking, and as input to the extraction unit. As a technical effect, the detection unit achieves significant improvements in detection accuracy, reduction of misjudgment, and processing speed compared to conventional systems by enabling automatic judgment and integrated evaluation of multiple criteria in high-dimensional feature space, without relying on human subjective judgment. Application fields include family album management, school event records, corporate event records, customer photo services in the tourism industry, and automatic album generation linked with SNS.

The extraction unit can extract photos in which faces are clearly shown or photos with good composition using face recognition technology. Face recognition technology may include, for example, Haar-like features or deep learning-based face recognition technology, but is not limited thereto. The extraction unit, for example, uses Haar-like features to extract photos in which faces are clearly shown. For instance, it recognizes faces based on features such as facial contours, eyes, nose, and mouth, and selects photos in which faces are clearly shown. Additionally, the extraction unit can use deep learning-based face recognition technology to extract photos in which faces are clearly shown. For example, the deep learning model learns facial features and selects photos in which faces are clearly shown. Furthermore, the extraction unit can also extract photos based on composition and image quality. For example, the extraction unit evaluates composition balance and color harmony to select good photos. By using face recognition technology, the extraction accuracy for good photos is improved. Some or all of the above-described processing in the extraction unit may be performed using AI or without using AI. For example, the extraction unit can use an AI model for extracting good photos using face recognition technology. Specifically, the extraction unit receives image tensors from the receiving unit (e.g., 224×224×3 RGB images, or 64 frames×224×224×3 spatiotemporal tensors for videos) as input. The extraction unit first uses a face detection model (e.g., YOLO-based or MTCNN) to extract face regions in the image, applies a Haar-like feature extractor or convolutional neural network (CNN) to the extracted face regions, and generates face feature vectors (e.g., 128 or 512 dimensions). The extraction unit calculates multiple indices such as edge strength, noise amount, landmark detection accuracy for eyes and mouth, and brightness histogram of the face region, and synthesizes them with weights to generate a “face clarity score.” For example, high edge strength, low noise amount, and high landmark detection accuracy in the face region result in a high score. Furthermore, the extraction unit applies a composition evaluation model (e.g., rule-of-thirds score, subject centering, color balance, histogram uniformity) to the entire image to calculate composition and image quality scores. These scores are output as numerical values such as “face clarity score 0.92,” “composition score 0.85,” “image quality score 0.88.” Examples of AI model output include good photo scores (e.g., 0.87), face ID (integer), face clarity label (1: clear, 0: unclear), composition label (1: good, 0: poor). In subsequent processing, the extraction unit uses these scores and labels for threshold judgment and ranking, and retains only good photos in the output list of the extraction unit. For example, only images with a good photo score of 0.8 or higher and a face clarity label of 1 are extracted. As a technical effect, the extraction unit achieves significant improvements in extraction accuracy, reduction of misjudgment, and processing speed compared to conventional systems by enabling automatic judgment and integrated evaluation of multiple criteria in high-dimensional feature space, without relying on human subjective judgment. Application fields include family album management, school event records, corporate event records, customer photo services in the tourism industry, and automatic album generation linked with SNS. Furthermore, the extraction unit can operate by combining multiple AI modules such as ResNet or Transformer-based face recognition models, composition evaluation models, and image quality evaluation models, thereby demonstrating high versatility and accuracy for various shooting conditions and subjects. Examples of AI input include face photos (128×128×3), group photos (512×512×3), video frame sequences (64×224×224×3), and examples of AI output include face ID (12345), face clarity score (0.93), composition score (0.88), good photo label (1). These outputs are also used as input to subsequent video editing and search units, contributing to the automation and efficiency of the entire system.

The editing unit can edit a video by combining videos or photos based on the duration or image specified by the user. The duration or image specified by the user may include, for example, video length, theme, style, but is not limited thereto. The editing unit, for example, combines photos and videos taken during a trip to automatically edit a 3-minute video when the user specifies “create a 3-minute travel video.” If the user specifies “create a video with an emotional atmosphere,” the editing unit adds emotional music and effects to create a video with an emotional atmosphere. The editing unit, for example, selects appropriate photos or videos based on video length, and edits by adding transitions and effects. The editing unit can also adjust the atmosphere of the video based on theme or style. For example, for an emotional theme, the editing unit adds emotional music and effects. By editing videos based on user specifications, videos tailored to user needs can be provided. Some or all of the above-described processing in the editing unit may be performed using AI or without using AI. For example, the editing unit can use an AI model for editing videos based on user specifications. Specifically, the editing unit receives as input the user-specified video length (e.g., 180 seconds), theme (e.g., emotional, fun, dynamic), and style (e.g., cinematic, documentary) as natural language text. The editing unit vectorizes these natural language inputs using a large language model-based text encoder, combines them with metadata of photos and videos obtained from the extraction unit (e.g., shooting date, face ID, composition score, event tag), and determines the optimal editing sequence. As a sequence determination algorithm, the editing unit uses reinforcement learning or beam search to select photo and video clips that fit within the user-specified video length, maximizing scene flow and storytelling. Furthermore, the editing unit automatically applies transition effects (e.g., fade, slide, zoom), selects BGM (e.g., piano music for emotional videos, uptempo music for fun videos), and effects (e.g., color correction, slow motion, text overlay). Examples of AI input include user-specified text (“create a 3-minute travel video”), photo ID list output from the extraction unit ([101, 102, 103]), metadata for each photo (face ID: 123, composition score: 0.88, shooting date: 2023 Aug. 1 10:00), video clips (64 frames×224×224×3). Examples of AI output include editing sequence (order of photo IDs and video IDs), display time for each scene (e.g., photo 101: 5 seconds, video 201: 10 seconds), applied effect list (fade-in, BGM: piano music, color correction: warm tone), final video file (MP4 format). In subsequent processing, the editing unit executes video rendering using GPU-based parallel computation clusters according to the AI output editing sequence, and generates the final video file. As a technical effect, the editing unit achieves significant improvements in editing efficiency, reduction of user burden, and adaptability to diverse video generation compared to conventional systems by enabling flexible instructions in natural language and integrated utilization of high-dimensional metadata, without relying on human manual editing. Application fields include family album video generation, school event digest creation, corporate event promotion videos, automatic video editing for customers in the tourism industry, and short movie generation for SNS posting. Furthermore, the editing unit can provide optimal editing results for diverse user requests and video themes by linking multiple AI modules (e.g., scene selection AI, BGM recommendation AI, effect application AI).

The registration unit can recognize family member face photos uploaded by the user and register them in a database. Family member face photos may include facial features recognized using face recognition technology, but are not limited thereto. The registration unit, for example, recognizes family member face photos uploaded by the user and registers them in a database. For instance, it extracts features such as facial contours, eyes, nose, and mouth using face recognition technology and registers them in a database. The registration unit can also optimize the database based on the number of faces to be registered and facial features. For example, the registration unit allows the user to upload multiple family member face photos and registers the features of each face in the database. By registering family member face photos in the database, searches based on face data become possible. Some or all of the above-described processing in the registration unit may be performed using AI or without using AI. For example, the registration unit can use an AI model for recognizing family member face photos using face recognition technology and registering them in a database. Specifically, the registration unit receives as input face photos uploaded by the user (e.g., 128×128×3 RGB images or multiple group photos). The registration unit uses a face detection model (e.g., YOLO-based or MTCNN) to extract face regions in the image, applies a convolutional neural network (CNN) or Transformer-based face recognition model to the extracted face regions, and generates face feature vectors (e.g., 128 or 512 dimensions). In addition to face feature vectors, the registration unit applies an age estimation model (e.g., age estimation CNN) and gender estimation model to generate metadata such as face ID, age estimation, and gender estimation. This information is registered in the database in formats such as face ID (integer), face feature vector (128 dimensions), age estimation (e.g., 5 years old), gender (0: male, 1: female). Examples of AI input include face photos (128×128×3), group photos (512×512×3), face region images (64×64×3), and examples of AI output include face ID (12345), face feature vector ([0.12, 0.34, . . . ]), age estimation (8), gender (1). In subsequent processing, the registration unit indexes face IDs and face feature vectors and optimizes the database structure to enable fast face search and similar face judgment. For example, by using approximate nearest neighbor search engines such as Annoy or FAISS, fast search in face feature vector space is realized. As a technical effect, the registration unit achieves significant improvements in registration accuracy, search speed, and reduction of user burden compared to conventional systems by enabling automatic feature extraction, metadata generation, and database optimization from images, without relying on manual face information input or labeling. Application fields include family album management, school event records, corporate employee face databases, customer face registration in the tourism industry, and SNS-linked face search services. Furthermore, the registration unit can improve registration accuracy and convenience by combining multiple AI technologies such as ensemble learning for integrating face features from multiple photos of the same person and automatic grouping by clustering face feature vectors.

The search unit can search for and display desired photos or videos based on the registered face data. Desired photos or videos may include search algorithms based on face data and display methods for search results, but are not limited thereto. The search unit, for example, quickly searches for and displays desired photos or videos based on the registered face data. For instance, the search unit analyzes the registered face data using face recognition technology to identify desired photos or videos. The search unit can also provide an interface for displaying search results to the user. For example, the search unit displays search results in thumbnail format, allowing the user to easily select desired photos or videos. By searching based on face data, desired photos or videos can be quickly found. Some or all of the above-described processing in the search unit may be performed using AI or without using AI. For example, the search unit can use an AI model for searching desired photos or videos using face recognition technology. Specifically, the search unit receives as input the user's search query (e.g., “photos of XX at age 5” in natural language text) or face photo (128×128×3). The search unit vectorizes the natural language query using a large language model-based text encoder, combines it with metadata such as face ID, age, and shooting date, and generates search conditions. If a face photo is input, the search unit extracts face feature vectors using a face detection model and face recognition model, and compares them with face feature vectors in the database using cosine similarity or Euclidean distance. As a search algorithm, the search unit uses approximate nearest neighbor search engines such as Annoy or FAISS to quickly extract relevant photos or videos from tens of thousands to millions of face feature vectors. Examples of AI input include search query (“photos of XX at age 5”), face photo (128×128×3), face ID (12345), age specification (5), and examples of AI output include search result list (photo ID array [101, 102, 103]), thumbnail images (64×64×3), search result scores (0.92, 0.88, 0.85). In subsequent processing, the search unit ranks the search result list, displays it in thumbnail format on the user interface, and allows the user to easily select desired photos or videos. As a technical effect, the search unit achieves significant improvements in search accuracy, search time reduction, and reduction of user burden compared to conventional systems by enabling fast matching of multidimensional metadata such as face feature vectors, age, and shooting date, without relying on human memory or manual search. Application fields include family album management, school event records, corporate employee search, customer photo search in the tourism industry, and SNS-linked face search services. Furthermore, the search unit can respond to diverse search needs by combining multiple AI technologies such as composite search of natural language queries with face data and metadata, and similar person search by clustering face feature vectors.

The receiving unit can estimate a user's emotion and adjust the timing of receiving photo or video data based on the estimated emotion. The receiving unit, for example, estimates a user's emotion and adjusts the timing of receiving photo or video data based on the estimated emotion. For instance, if the user is feeling stressed, the receiving timing is delayed so that data is received when the user is relaxed. If the user is relaxed, data is received immediately to provide smooth operation. Furthermore, if the user is in a hurry, the receiving timing is accelerated to receive data quickly. By adjusting the receiving timing according to the user's emotion, the user's burden is reduced. Emotion estimation is realized using, for example, an emotion engine or generative AI with emotion estimation functions. Generative AI may include text generation AI (e.g., LLM) or multimodal generative AI, but is not limited thereto. Some or all of the above-described processing in the receiving unit may be performed using AI or without using AI. For example, the receiving unit can use an AI model for estimating a user's emotion and adjusting the receiving timing based on the emotion. Specifically, the receiving unit receives as input multimodal data such as user voice data (e.g., 5 seconds of audio waveform), face image (128×128×3), and text input (e.g., “I'm busy now” in natural language). The receiving unit uses a voice emotion recognition model (e.g., acoustic feature extraction+RNN), a facial expression recognition model (e.g., CNN+expression classification), and a text emotion analysis model (e.g., large language model) to calculate emotion scores (e.g., stress level 0.8, relaxation level 0.2, urgency level 0.7) for each modality. The receiving unit integrates these emotion scores with weights and determines the final user emotion label (e.g., stress, relaxation, urgency). Examples of AI input include audio waveform (16 kHz, 5 seconds), face image (128×128×3), text (“I'm busy now”), biometric sensor values (heart rate 80 bpm), and examples of AI output include emotion label (stress), emotion score (0.85), recommended receiving timing (delayed, immediate, early). In subsequent processing, the receiving unit automatically adjusts the timing of data reception according to the estimated emotion label using a receiving timing control module, optimizing the user experience. As a technical effect, the receiving unit achieves significant improvements in receiving experience, reduction of user burden, and efficiency of reception compared to conventional systems by enabling multimodal emotion estimation and automatic timing control, without relying on human subjective judgment or manual operation. Application fields include family album management, school event records, corporate event reception, customer data reception in the tourism industry, and SNS-linked automatic reception services. Furthermore, the receiving unit can flexibly respond to diverse user states and environments by combining multiple emotion estimation AI models.

The receiving unit can analyze a user's past data reception history and select an optimal reception method. Past data reception history may include, for example, reception date and time, data type, number of receptions, but is not limited thereto. The receiving unit, for example, preferentially suggests reception methods frequently used by the user in the past (e.g., via Wi-Fi or USB connection). The receiving unit can also suggest optimal reception methods for specific time periods based on the user's past reception history. Furthermore, the receiving unit can select the optimal reception method based on devices used by the user in the past. For example, the receiving unit suggests the optimal reception method based on the connection method of devices previously used by the user. By analyzing past data reception history, the optimal reception method can be provided. Some or all of the above-described processing in the receiving unit may be performed using AI or without using AI. For example, the receiving unit can use an AI model for analyzing past data reception history and selecting an optimal reception method. Specifically, the receiving unit receives as input a user-specific reception history database (e.g., structured table including reception date and time timestamp, data type label, reception method ID, device ID, reception success/failure flag). The receiving unit preprocesses these history data as time series vectors (e.g., vectorizing each reception event, using the most recent 100 events as one series), and applies a time series analysis model (e.g., LSTM or Transformer Encoder) to extract selection tendencies for reception methods and usage patterns by time period. The receiving unit calculates multiple features such as usage frequency distribution by reception method, reception success rate by day of week and time period, connection stability score by device, and integrates them with weights to generate a “reception method recommendation score.” Examples of AI input include reception history vectors (e.g., 100 events×8 dimensions), reception method categories (Wi-Fi, USB, Bluetooth), device ID (integer), reception time (UNIX timestamp), and examples of AI output include reception method recommendation score (Wi-Fi: 0.92, USB: 0.85, Bluetooth: 0.60), recommended reception method label (Wi-Fi), recommendation reason text (“Wi-Fi had the highest reception success rate in the past 30 days”). In subsequent processing, the receiving unit preferentially displays the reception method with the highest recommendation score on the user interface, allowing the user to select it with one click. As a technical effect, the receiving unit achieves optimization of reception methods, reduction of reception failure rate, and reduction of user operation burden compared to conventional systems by enabling high-dimensional feature extraction and time series pattern analysis of history data, without relying on human memory or heuristics. Application fields include family album management systems, corporate data collection terminals, customer data reception in the tourism industry, photo reception for school events, and SNS-linked automatic reception services. Furthermore, the receiving unit can realize more advanced reception optimization functions by statistically analyzing the history of multiple users, recommending by user type through clustering, and detecting special patterns during seasonal changes or events.

The receiving unit can perform filtering based on the user's current project or area of interest at the time of data reception. The user's current project or area of interest may include, for example, project management tools, survey results, past activity history, but is not limited thereto. The receiving unit, for example, prioritizes reception of travel-related photo or video data when the user is working on a travel project. If the user is interested in hobby photography, the receiving unit can also prioritize reception of related data. Furthermore, if the user is working on a work project, the receiving unit can prioritize reception of work-related data. By filtering data based on the user's project or area of interest, highly relevant data can be preferentially received. Some or all of the above-described processing in the receiving unit may be performed using AI or without using AI. For example, the receiving unit can use an AI model for filtering data based on the user's current project or area of interest. Specifically, the receiving unit receives as input user project management data (e.g., ongoing project name, project type, start/end date, related tags), survey response data (e.g., area of interest scores, recent activity trends), and past reception data (e.g., reception date and time, data type, project ID). The receiving unit preprocesses this information as categorical or numerical vectors and extracts features for each project or area of interest. As AI models, project classification models (e.g., multilayer perceptron or Transformer Encoder) and area of interest estimation models are used to calculate relevance scores with reception target data (e.g., photo/video metadata, tags, shooting date, location). Examples of AI input include project category vectors (e.g., travel: 1, work: 0, hobby: 1), area of interest scores (0.8: photo, 0.2: video), reception data meta-information (tags: “travel,” “family”). Examples of AI output include reception priority scores (0.95: travel photos, 0.60: work videos), reception decision labels (1: receive, 0: not receive), recommendation reason text (“related to ongoing travel project”). In subsequent processing, the receiving unit displays only data with high priority scores in the reception candidate list, allowing the user to efficiently select relevant data. As a technical effect, the receiving unit achieves improved reception efficiency, reduction of erroneous reception, and reduction of user burden compared to conventional systems by enabling multidimensional feature extraction and automatic matching of projects and areas of interest, without relying on human subjective judgment or manual filtering. Application fields include family album management, corporate project management, school event records, customer data reception in the tourism industry, and SNS-linked automatic reception services. Furthermore, the receiving unit can be equipped with online learning and model update functions based on user feedback to respond to simultaneous progress of multiple projects and dynamic changes in areas of interest.

The receiving unit can estimate a user's emotion and determine the priority of data to be received based on the estimated emotion. The receiving unit, for example, estimates a user's emotion and determines the priority of data to be received based on the estimated emotion. For instance, if the user is feeling stressed, important data is preferentially received and other data is postponed. If the user is relaxed, all data can be received equally. Furthermore, if the user is in a hurry, the most important data is received with the highest priority. By determining the priority of data according to the user's emotion, important data can be preferentially received. Emotion estimation is realized using, for example, an emotion engine or generative AI with emotion estimation functions. Generative AI may include text generation AI (e.g., LLM) or multimodal generative AI, but is not limited thereto. Some or all of the above-described processing in the receiving unit may be performed using AI or without using AI. For example, the receiving unit can use an AI model for estimating a user's emotion and determining the priority of data based on the emotion. Specifically, the receiving unit receives as input user voice data (e.g., 5 seconds of audio waveform), face image (128×128×3), text input (e.g., “I'm busy now”), and biometric sensor values (heart rate, skin conductance, etc.). The receiving unit uses a voice emotion recognition model (e.g., acoustic feature extraction+RNN), a facial expression recognition model (e.g., CNN+expression classification), and a text emotion analysis model (e.g., large language model) to calculate emotion scores (e.g., stress level 0.8, relaxation level 0.2, urgency level 0.7) for each modality. The receiving unit integrates these emotion scores with weights and determines the final user emotion label (e.g., stress, relaxation, urgency). Furthermore, the receiving unit combines importance metadata of the data to be received (e.g., importance label, project relevance, shooting date) with the emotion label, applies a priority determination algorithm (e.g., rule-based+machine learning), and optimizes the reception order. Examples of AI input include audio waveform (16 kHz, 5 seconds), face image (128×128×3), text (“I'm busy now”), biometric sensor values (heart rate 80 bpm), data importance label (1: high, 0: low). Examples of AI output include emotion label (stress), data reception priority list (data ID: priority score), recommended reception order (e.g., Data A→Data B→Data C). In subsequent processing, the receiving unit executes reception processing in order of highest priority, optimizing the user experience. As a technical effect, the receiving unit achieves improved reception efficiency, prevention of missing important data, and reduction of user burden compared to conventional systems by enabling multimodal emotion estimation and automatic priority control, without relying on human subjective judgment or manual prioritization. Application fields include family album management, corporate event reception, customer data reception in the tourism industry, school event records, and SNS-linked automatic reception services. Furthermore, the receiving unit can implement a function to dynamically recalculate reception priority in real time according to changes in user emotion.

The receiving unit can consider a user's geographic location information at the time of data reception and preferentially receive highly relevant data. Geographic location information may include, for example, GPS data, location information services, but is not limited thereto. The receiving unit, for example, prioritizes reception of photos or videos related to the travel destination based on geographic location information when the user is traveling. If the user is at home, the receiving unit can prioritize reception of data taken around the home. Furthermore, if the user is participating in a specific event, the receiving unit can prioritize reception of data related to that event. By considering geographic location information, highly relevant data can be preferentially received. Some or all of the above-described processing in the receiving unit may be performed using AI or without using AI. For example, the receiving unit can use an AI model for considering geographic location information and preferentially receiving highly relevant data. Specifically, the receiving unit receives as input GPS coordinates (latitude and longitude) obtained from the user terminal, location ID from location information services, current event information (e.g., event name, venue, event time), and shooting location metadata of the data to be received (e.g., photo/video shooting coordinates, location tags). The receiving unit calculates the spatial distance between the current location and the shooting location of the data to be received, assigning a higher relevance score for closer distances. Furthermore, the receiving unit calculates event relevance scores based on the match of event information and location tags. As AI models, spatial distance calculation+rule-based scoring or gradient boosting models using geographic features can be used. Examples of AI input include current location coordinates (35.6895, 139.6917), reception data shooting coordinates (35.6900, 139.6920), location tags (“Tokyo Station,” “Home”), event ID (12345). Examples of AI output include reception relevance score (0.98: travel destination photo, 0.85: home photo), reception priority list (data ID: priority), recommended reception data label (“event-related”). In subsequent processing, the receiving unit displays data with high relevance scores in order in the reception candidate list, allowing the user to efficiently select relevant data. As a technical effect, the receiving unit achieves improved reception efficiency, prevention of missing relevant data, and reduction of user burden compared to conventional systems by enabling automatic analysis of geographic features and spatial matching, without relying on human subjective judgment or manual location specification. Application fields include family album management, customer data reception in the tourism industry, event records, school event records, and SNS-linked automatic reception services. Furthermore, the receiving unit can also analyze spatiotemporal patterns such as movement routes and stay duration, and optimize reception based on user behavior history.

The receiving unit can analyze a user's social media activity at the time of data reception and receive relevant data. Social media activity may include, for example, post content, number of likes, number of followers, but is not limited thereto. The receiving unit, for example, prioritizes reception of photos or videos shared by the user on social media. The receiving unit can also prioritize reception of photos or videos tagged by the user on social media. Furthermore, the receiving unit can prioritize reception of data related to posts by accounts followed by the user on social media. By analyzing social media activity, relevant data can be preferentially received. Some or all of the above-described processing in the receiving unit may be performed using AI or without using AI. For example, the receiving unit can use an AI model for analyzing social media activity and receiving relevant data. Specifically, the receiving unit receives as input post data obtained from the user's social media API (e.g., post text, image URL, post date and time, tags, number of likes, number of comments, number of followers), and metadata of the data to be received (e.g., photo/video tags, shooting date, related account ID). The receiving unit vectorizes post content using a natural language processing model (e.g., large language model), extracts features such as tag and account ID match, engagement indicators (number of likes, number of comments). As AI models, similarity calculation of post content and reception data tags/content (cosine similarity), engagement-weighted scoring, clustering of related accounts are combined. Examples of AI input include post text (“Family travel memories”), tags (“travel,” “family”), number of likes (120), reception data tags (“travel”), account ID (67890). Examples of AI output include reception relevance score (0.97: shared photo, 0.85: tag-matched video), reception priority list (data ID: priority), recommended reception data label (“high engagement”). In subsequent processing, the receiving unit displays data with high relevance scores preferentially in the reception candidate list, allowing the user to efficiently select relevant data. As a technical effect, the receiving unit achieves improved reception efficiency, prevention of missing relevant data, and reduction of user burden compared to conventional systems by enabling automatic analysis of post content, tags, and engagement indicators, without relying on human subjective judgment or manual social media linkage. Application fields include family album management, SNS-linked automatic reception services, corporate event records, customer data reception in the tourism industry, and school event records. Furthermore, the receiving unit can realize more advanced social media linkage functions such as integrated analysis of multiple SNS platforms and automatic adjustment of reception priority based on trend detection.

The detection unit can estimate a user's emotion and adjust the criteria for detecting duplicate photos or erroneous photos based on the estimated emotion. The detection unit, for example, estimates a user's emotion and adjusts the criteria for detecting duplicate photos or erroneous photos based on the estimated emotion. For instance, if the user is feeling stressed, the detection unit applies strict criteria to detect duplicate photos or erroneous photos, reducing the user's burden. If the user is relaxed, the detection unit applies lenient criteria, providing the user with more options. Furthermore, if the user is in a hurry, the detection unit performs rapid detection, retaining only important photos. By adjusting the detection criteria according to the user's emotion, the user's burden is reduced. Emotion estimation is realized using, for example, an emotion engine or generative AI with emotion estimation functions. Generative AI may include text generation AI (e.g., LLM) or multimodal generative AI, but is not limited thereto. Some or all of the above-described processing in the detection unit may be performed using AI or without using AI. For example, the detection unit can use an AI model for estimating a user's emotion and adjusting the criteria for detecting duplicate photos or erroneous photos based on the emotion. Specifically, the detection unit receives as input user voice data (e.g., 5 seconds of audio waveform), face image (128×128×3), text input (e.g., “I'm busy now”), and biometric sensor values (heart rate, skin conductance, etc.). The detection unit uses a voice emotion recognition model (e.g., acoustic feature extraction+RNN), a facial expression recognition model (e.g., CNN+expression classification), and a text emotion analysis model (e.g., large language model) to calculate emotion scores (e.g., stress level 0.8, relaxation level 0.2, urgency level 0.7) for each modality. The detection unit integrates these emotion scores with weights and determines the final user emotion label (e.g., stress, relaxation, urgency). The detection unit processes image tensors received from the receiving unit (e.g., 224×224×3 RGB images, or 64 frames×224×224×3 spatiotemporal tensors for videos) using image classification models equipped with convolutional neural networks and self-attention mechanisms to calculate duplicate scores (cosine similarity or feature vector distance) and erroneous photo scores (backlight degree, out-of-focus degree, brightness histogram of face regions). The detection unit dynamically changes the thresholds for duplicate scores and erroneous photo scores according to the user emotion label. For example, in a stress state, the duplicate threshold is set to 0.85, eliminating more duplicate photos or erroneous photos. In a relaxed state, the threshold is relaxed to 0.95, leaving more options for the user. In an urgent state, only images with high quality scores are retained, and the detection process itself is executed in high-speed mode. Examples of AI input include audio waveform (16 kHz, 5 seconds), face image (128×128×3), text (“I'm busy now”), biometric sensor values (heart rate 80 bpm), image tensor (224×224×3). Examples of AI output include emotion label (stress), duplicate score (0.95), erroneous photo label (1: backlit, 0: normal), detection threshold (0.85). In subsequent processing, the detection unit automatically judges and eliminates duplicate photos or erroneous photos based on the emotion label and detection threshold, optimizing input data for the extraction unit. As a technical effect, the detection unit achieves improved detection accuracy, reduction of user burden, and improved adaptability to situations compared to conventional systems by enabling multimodal emotion estimation and automatic threshold control, without relying on human subjective judgment or manual criteria changes. Application fields include family album management, corporate event records, customer photo services in the tourism industry, and automatic album generation linked with SNS. Furthermore, the detection unit realizes flexible optimization of detection criteria according to user state by linking emotion estimation AI and image classification AI, achieving significant improvement in user experience compared to conventional uniform judgment methods.

The detection unit can improve detection accuracy by considering interrelationships among photos or videos at the time of detection. Interrelationships among photos or videos may include, for example, shooting date and time, shooting location, subject commonality, but are not limited thereto. The detection unit, for example, groups photos or videos taken at the same event and detects duplicate photos by considering interrelationships. The detection unit can also detect erroneous photos by considering interrelationships based on shooting date and time. Furthermore, the detection unit can analyze the content of photos or videos and improve detection accuracy by considering interrelationships. For example, the detection unit groups photos or videos taken at the same event and detects duplicate photos by considering interrelationships. By considering interrelationships among photos or videos, detection accuracy is improved. Some or all of the above-described processing in the detection unit may be performed using AI or without using AI. For example, the detection unit can use an AI model for improving detection accuracy by considering interrelationships among photos or videos. Specifically, the detection unit receives as input metadata of photos or videos received from the receiving unit (e.g., shooting date and time timestamp, shooting location GPS coordinates, event ID, subject tag, face ID list, photographer ID) and image/video tensors (e.g., 224×224×3, 64 frames×224×224×3). The detection unit first applies time series clustering (e.g., DBSCAN or time series K-means) and spatial clustering (e.g., spatial grouping using Haversine distance) based on metadata to automatically generate groups for the same event or nearby shooting. The detection unit generates high-dimensional feature vectors (e.g., 512 dimensions) for images or videos within each group using convolutional neural networks or Transformer-based feature extraction models, and calculates duplicate scores using cosine similarity or Euclidean distance. Furthermore, the detection unit integrates multiple interrelationship features such as subject tag and face ID match, proximity of shooting date and time, and spatial distance of shooting location with weights, and dynamically adjusts thresholds for duplicate judgment and erroneous photo judgment. Examples of AI input include shooting date and time (2023 Aug. 1 10:00), shooting location (35.6895, 139.6917), event ID (12345), face ID list ([101, 102]), image tensor (224×224×3). Examples of AI output include group ID (1: Event A), duplicate score (0.97), erroneous photo label (1: backlit, 0: normal), detection priority (high). In subsequent processing, the detection unit automatically judges and eliminates duplicate photos or erroneous photos for each group, optimizing input data for the extraction unit. As a technical effect, the detection unit achieves improved detection accuracy, reduction of misjudgment, and improved processing efficiency compared to conventional systems by enabling multidimensional feature analysis integrating time, space, subject, and event information, without relying on human subjective grouping or manual judgment. Application fields include family album management, school event records, corporate event records, customer photo services in the tourism industry, and automatic album generation linked with SNS. Furthermore, the detection unit enables flexible grouping and judgment by event or photographer, achieving significant improvement in accuracy and user experience compared to conventional single-image judgment methods.

The detection unit can perform detection by considering attribute information of the photographer of the photos or videos at the time of detection. Photographer attribute information may include, for example, age, gender, shooting experience, but is not limited thereto. The detection unit, for example, preferentially detects photos or videos taken by a specific photographer and eliminates duplicates or errors. The detection unit can also adjust criteria for detecting erroneous photos by considering the photographer's shooting style. Furthermore, the detection unit can detect duplicate photos or erroneous photos based on the photographer's past shooting history. For example, the detection unit preferentially detects photos or videos taken by a specific photographer and eliminates duplicates or errors. By considering photographer attribute information, detection accuracy is improved. Some or all of the above-described processing in the detection unit may be performed using AI or without using AI. For example, the detection unit can use an AI model for performing detection by considering photographer attribute information. Specifically, the detection unit receives as input metadata of photos or videos (photographer ID, age, gender, years of shooting experience, past shooting history, shooting style features) and image/video tensors (224×224×3, 64 frames×224×224×3). The detection unit refers to the past shooting history database for each photographer ID, extracts features such as shooting style (e.g., composition tendency, exposure settings, subject selection tendency). The detection unit inputs photographer attribute vectors (e.g., age: 35, gender: 1, experience: 5 years, style: “portrait-oriented”) in addition to convolutional neural network or Transformer-based image classification models, and optimizes thresholds for duplicate scores and erroneous photo judgment for each photographer. For example, for beginner photographers, criteria for out-of-focus or backlit judgment are made stricter, while for experienced photographers, criteria focusing on composition or artistry are applied. Examples of AI input include photographer ID (56789), age (35), gender (1), years of experience (5), shooting style vector ([0.8, 0.1, 0.1]), image tensor (224×224×3). Examples of AI output include duplicate score (0.93), erroneous photo label (1: out-of-focus, 0: normal), judgment threshold (0.90), photographer adaptation score (high). In subsequent processing, the detection unit automatically judges and eliminates duplicate photos or erroneous photos based on criteria adapted to photographer attributes, optimizing input data for the extraction unit. As a technical effect, the detection unit achieves improved detection accuracy, reduction of misjudgment, and improved user satisfaction compared to conventional systems by enabling multidimensional feature analysis and automatic optimization of judgment criteria based on photographer attributes, history, and style, without relying on human subjective photographer evaluation or manual criteria changes. Application fields include family album management, school event records, corporate event records, customer photo services in the tourism industry, and automatic album generation linked with SNS. Furthermore, the detection unit can flexibly respond to diverse user needs by individual optimization for each photographer, compared to conventional uniform judgment methods.

The extraction unit can estimate a user's emotion and adjust the criteria for extracting good photos based on the estimated emotion. The extraction unit, for example, estimates a user's emotion and adjusts the criteria for extracting good photos based on the estimated emotion. For instance, if the user is feeling stressed, the extraction unit applies strict criteria to extract good photos, reducing the user's burden. If the user is relaxed, the extraction unit applies lenient criteria, providing the user with more options. Furthermore, if the user is in a hurry, the extraction unit performs rapid extraction, retaining only important photos. By adjusting the extraction criteria according to the user's emotion, the user's burden is reduced. Emotion estimation is realized using, for example, an emotion engine or generative AI with emotion estimation functions. Generative AI may include text generation AI (e.g., LLM) or multimodal generative AI, but is not limited thereto. Some or all of the above-described processing in the extraction unit may be performed using AI or without using AI. For example, the extraction unit can use an AI model for estimating a user's emotion and adjusting the criteria for extracting good photos based on the emotion. Specifically, the extraction unit receives as input user voice data (e.g., 5 seconds of audio waveform), face image (128×128×3), text input (e.g., “I'm busy now”), and biometric sensor values (heart rate, skin conductance, etc.). The extraction unit uses a voice emotion recognition model (e.g., acoustic feature extraction+RNN), a facial expression recognition model (e.g., CNN+expression classification), and a text emotion analysis model (e.g., large language model) to calculate emotion scores (e.g., stress level 0.8, relaxation level 0.2, urgency level 0.7) for each modality. The extraction unit integrates these emotion scores with weights and determines the final user emotion label (e.g., stress, relaxation, urgency). The extraction unit processes image tensors received from the receiving unit or detection unit (e.g., 224×224×3 RGB images, or 64 frames×224×224×3 spatiotemporal tensors for videos) using face detection models (e.g., YOLO-based or MTCNN), face recognition models (ResNet-based or Transformer-based), and composition evaluation models (e.g., rule-of-thirds score, subject centering, color balance) to calculate multiple evaluation indices such as face clarity score, composition score, and image quality score. The extraction unit dynamically changes the threshold for good photo scores and the weights of evaluation indices according to the user emotion label. For example, in a stress state, the threshold for good photo scores is set to 0.85, and only carefully selected photos are extracted. In a relaxed state, the threshold is relaxed to 0.75, leaving more photos as candidates. In an urgent state, only photos with high face clarity and composition scores are preferentially extracted, and the process itself is executed in high-speed mode. Examples of AI input include audio waveform (16 kHz, 5 seconds), face image (128×128×3), text (“I'm busy now”), biometric sensor values (heart rate 80 bpm), image tensor (224×224×3). Examples of AI output include emotion label (stress), good photo score (0.87), face clarity score (0.93), extraction threshold (0.85). In subsequent processing, the extraction unit automatically judges and extracts good photos based on the emotion label and extraction threshold, optimizing input data for the editing unit or search unit. As a technical effect, the extraction unit achieves improved extraction accuracy, reduction of user burden, and improved adaptability to situations compared to conventional systems by enabling multimodal emotion estimation and automatic threshold control, without relying on human subjective judgment or manual criteria changes. Application fields include family album management, corporate event records, customer photo services in the tourism industry, and automatic album generation linked with SNS. Furthermore, the extraction unit realizes flexible optimization of extraction criteria according to user state by linking emotion estimation AI and face/composition evaluation AI, achieving significant improvement in user experience compared to conventional uniform judgment methods.

The extraction unit can improve extraction accuracy by considering interrelationships among photos or videos at the time of extraction. Interrelationships among photos or videos may include, for example, shooting date and time, shooting location, subject commonality, but are not limited thereto. The extraction unit, for example, groups photos or videos taken at the same event and extracts good photos by considering interrelationships. The extraction unit can also extract good photos by considering interrelationships based on shooting date and time. Furthermore, the extraction unit can analyze the content of photos or videos and improve extraction accuracy by considering interrelationships. For example, the extraction unit groups photos or videos taken at the same event and extracts good photos by considering interrelationships. By considering interrelationships among photos or videos, extraction accuracy is improved. Some or all of the above-described processing in the extraction unit may be performed using AI or without using AI. For example, the extraction unit can use an AI model for improving extraction accuracy by considering interrelationships among photos or videos. Specifically, the extraction unit receives as input metadata of photos or videos received from the receiving unit or detection unit (shooting date and time timestamp, shooting location GPS coordinates, event ID, subject tag, face ID list, photographer ID) and image/video tensors (224×224×3, 64 frames×224×224×3). The extraction unit first applies time series clustering (e.g., DBSCAN or time series K-means) and spatial clustering (e.g., spatial grouping using Haversine distance) based on metadata to automatically generate groups for the same event or nearby shooting. The extraction unit calculates multiple evaluation indices such as face clarity score, composition score, and image quality score for images or videos within each group using face detection models (YOLO-based or MTCNN), face recognition models (ResNet-based or Transformer-based), and composition evaluation models (e.g., rule-of-thirds score, subject centering, color balance). The extraction unit integrates multiple interrelationship features such as subject commonality within the group, event tag match, proximity of shooting date and time, and spatial distance of shooting location with weights to generate good photo scores. Examples of AI input include shooting date and time (2023 Aug. 1 10:00), shooting location (35.6895, 139.6917), event ID (12345), face ID list ([101, 102]), image tensor (224×224×3). Examples of AI output include group ID (1: Event A), good photo score (0.92), face clarity score (0.93), composition score (0.88). In subsequent processing, the extraction unit automatically judges and extracts good photos for each group, optimizing input data for the editing unit or search unit. As a technical effect, the extraction unit achieves improved extraction accuracy, reduction of misjudgment, and improved processing efficiency compared to conventional systems by enabling multidimensional feature analysis integrating time, space, subject, and event information, without relying on human subjective grouping or manual judgment. Application fields include family album management, school event records, corporate event records, customer photo services in the tourism industry, and automatic album generation linked with SNS. Furthermore, the extraction unit enables flexible grouping and judgment by event or photographer, achieving significant improvement in accuracy and user experience compared to conventional single-image judgment methods.

The extraction unit can perform extraction by considering attribute information of the photographer of the photos or videos at the time of extraction. Photographer attribute information may include, for example, age, gender, shooting experience, but is not limited thereto. The extraction unit, for example, preferentially extracts photos or videos taken by a specific photographer and selects good photos. The extraction unit can also adjust criteria for extracting good photos by considering the photographer's shooting style. Furthermore, the extraction unit can extract good photos based on the photographer's past shooting history. For example, the extraction unit preferentially extracts photos or videos taken by a specific photographer and selects good photos. By considering photographer attribute information, extraction accuracy is improved. Some or all of the above-described processing in the extraction unit may be performed using AI or without using AI. For example, the extraction unit can use an AI model for performing extraction by considering photographer attribute information. Specifically, the extraction unit receives as input metadata of photos or videos (photographer ID, age, gender, years of shooting experience, past shooting history, shooting style features) and image/video tensors (224×224×3, 64 frames×224×224×3). The extraction unit refers to the past shooting history database for each photographer ID, extracts features such as shooting style (e.g., composition tendency, exposure settings, subject selection tendency). The extraction unit inputs photographer attribute vectors (e.g., age: 35, gender: 1, experience: 5 years, style: “portrait-oriented”) in addition to face detection models (YOLO-based or MTCNN), face recognition models (ResNet-based or Transformer-based), and composition evaluation models (e.g., rule-of-thirds score, subject centering, color balance), and optimizes thresholds for good photo scores and weights of evaluation indices for each photographer. For example, for beginner photographers, face clarity and composition scores are emphasized, while for experienced photographers, criteria focusing on artistry and uniqueness are applied. Examples of AI input include photographer ID (56789), age (35), gender (1), years of experience (5), shooting style vector ([0.8, 0.1, 0.1]), image tensor (224×224×3). Examples of AI output include good photo score (0.93), face clarity score (0.95), composition score (0.90), extraction threshold (0.90), photographer adaptation score (high). In subsequent processing, the extraction unit automatically judges and extracts good photos based on criteria adapted to photographer attributes, optimizing input data for the editing unit or search unit. As a technical effect, the extraction unit achieves improved extraction accuracy, reduction of misjudgment, and improved user satisfaction compared to conventional systems by enabling multidimensional feature analysis and automatic optimization of judgment criteria based on photographer attributes, history, and style, without relying on human subjective photographer evaluation or manual criteria changes. Application fields include family album management, school event records, corporate event records, customer photo services in the tourism industry, and automatic album generation linked with SNS. Furthermore, the extraction unit can flexibly respond to diverse user needs by individual optimization for each photographer, compared to conventional uniform judgment methods.

The editing unit is capable of estimating a user's emotion and adjusting the video editing method based on the estimated emotion. For example, the editing unit estimates the user's emotion and adjusts the video editing method according to the estimated emotion. For instance, if the user is relaxed, the editing unit edits a video that progresses at a leisurely pace. If the user is in a hurry, the editing unit can edit a short video that focuses on key points. Furthermore, if the user is excited, the editing unit can edit a video with visually stimulating effects. By adjusting the editing method according to the user's emotion, videos tailored to the user's needs can be provided. Emotion estimation is realized, for example, by using an emotion engine or an emotion estimation function utilizing generative AI. Generative AI may include, for example, text generation AI (such as LLM) or multimodal generative AI, but is not limited to these examples. Some or all of the above-described processing in the editing unit may be performed using AI or without using AI. For example, the editing unit may perform editing using an AI model that estimates the user's emotion and adjusts the video editing method based on the emotion. Specifically, the editing unit receives, as input, user voice data (e.g., 5 seconds of audio waveform), face images (128×128×3), text input (e.g., “I am excited now”), and biometric sensor values (heart rate, skin conductance, etc.). The editing unit uses a voice emotion recognition model (e.g., acoustic feature extraction+RNN), a facial expression recognition model (e.g., CNN+expression classification), and a text emotion analysis model (e.g., large language model) to calculate emotion scores for each modality (e.g., relaxation level 0.7, excitement level 0.8, urgency level 0.6, etc.). The editing unit integrates these emotion scores with weights and determines a final user emotion label (e.g., relaxed, excited, hurried). The editing unit processes metadata of photos and videos received from the extraction unit (e.g., shooting date and time, face ID, composition score, event tag, etc.) and image/video tensors (e.g., 224×224×3, 64 frames×224×224×3) as input data. The editing unit dynamically changes the parameters of the editing sequence determination algorithm (e.g., reinforcement learning, beam search, rule-based) and effect application algorithm according to the user emotion label. For example, in a relaxed state, the scene transition interval is lengthened, a leisurely BGM is selected, and transition effects are mainly set to fade. In a hurried state, only important scenes are extracted, the entire video is shortened, and fast-tempo BGM and cut-in/cut-out effects are frequently used. In an excited state, color correction, zoom, slow motion, dynamic transitions, and effects (e.g., flash, particles) are automatically applied. Examples of AI input include audio waveform (16 kHz, 5 seconds), face image (128×128×3), text (“I am excited now”), biometric sensor value (heart rate 90 bpm), photo ID list output from the extraction unit ([101, 102, 103]), metadata for each photo (face ID: 123, composition score: 0.88, shooting date and time: 2023 Aug. 1 10:00, etc.), and video clips (64 frames×224×224×3). Examples of AI output include emotion label (excited), editing sequence (order of photo IDs and video IDs), display time for each scene (e.g., photo 101: 3 seconds, video 201: 7 seconds), applied effect list (zoom-in, BGM: up-tempo music, color correction: vivid, etc.), and final video file (MP4 format). In subsequent processing, the editing unit executes video rendering processing using a parallel computation cluster with GPUs according to the editing sequence output by the AI, and generates the final video file. As a technical effect, the editing unit achieves optimized video generation, improved editing efficiency, and enhanced user satisfaction according to the user's state by multimodal emotion estimation and automatic editing parameter control, without relying on subjective human editing work or manual effect application. Application fields include family album video generation, school event digest creation, corporate event promotion videos, automatic video editing for tourism customers, and short movie generation for SNS posting. Furthermore, by linking emotion estimation AI and editing AI, the editing unit realizes flexible optimization of editing criteria according to the user's state, achieving a significant improvement in user experience compared to conventional uniform editing methods.

The editing unit can improve editing accuracy by considering interrelationships among photos and videos during editing. Such interrelationships may include, for example, shooting date and time, shooting location, and subject commonality, but are not limited thereto. For example, the editing unit groups photos and videos taken at the same event and edits them considering their interrelationships. The editing unit may also edit based on the shooting date and time of photos and videos, taking interrelationships into account. Furthermore, the editing unit can analyze the content of photos and videos and improve editing accuracy by considering interrelationships. For example, the editing unit groups photos and videos taken at the same event and edits them considering their interrelationships. By considering interrelationships among photos and videos, editing accuracy is improved. Some or all of the above-described processing in the editing unit may be performed using AI or without using AI. For example, the editing unit may perform editing using an AI model that improves editing accuracy by considering interrelationships among photos and videos. Specifically, the editing unit receives, as input, metadata of photos and videos received from the receiving unit or extraction unit (shooting date and time timestamp, shooting location GPS coordinates, event ID, subject tag, face ID list, photographer ID, etc.) and image/video tensors (224×224×3, 64 frames×224×224×3). The editing unit first applies time-series clustering (e.g., DBSCAN or time-series K-means) and spatial clustering (e.g., spatial grouping using Haversine distance) based on metadata to automatically generate same-event or closely shot groups. For images and videos within a group, the editing unit generates high-dimensional feature vectors (e.g., 512 dimensions) using convolutional neural networks or Transformer-based feature extraction models, and calculates content similarity scores using cosine similarity or Euclidean distance. Furthermore, the editing unit integrates multiple interrelationship features such as subject tag and face ID match, proximity of shooting date and time, and spatial distance of shooting location with weights, and inputs them into the editing sequence determination algorithm (e.g., reinforcement learning, beam search). For example, within the same event group, the editing unit determines the order emphasizing story and chronological flow, and optimizes scene transitions and effect application on a group basis. Examples of AI input include shooting date and time (2023 Aug. 1 10:00), shooting location (35.6895, 139.6917), event ID (12345), face ID list ([101, 102]), and image tensor (224×224×3). Examples of AI output include group ID (1: Event A), editing sequence (order of photo IDs and video IDs), scene transition list (fade, slide, etc.), and story score (0.92). In subsequent processing, the editing unit automatically generates editing sequences for each group, executes video rendering processing using a parallel computation cluster with GPUs, and generates the final video file. As a technical effect, the editing unit achieves improved editing accuracy, reduced erroneous editing, and increased processing efficiency by multidimensional feature analysis integrating spatiotemporal, subject, and event information and automatic editing sequence generation, without relying on subjective human grouping or manual editing. Application fields include family album video generation, school event digest creation, corporate event promotion videos, automatic video editing for tourism customers, and short movie generation for SNS posting. Furthermore, the editing unit enables flexible editing and story generation by event or photographer unit, achieving significant improvement in accuracy and user experience compared to conventional single-image/video editing methods.

The editing unit can perform editing by considering attribute information of the photographer of photos and videos during editing. Such attribute information may include, for example, age, gender, and shooting experience, but is not limited thereto. For example, the editing unit may preferentially edit photos and videos taken by a specific photographer to create a good video. The editing unit may also adjust editing criteria by considering the photographer's shooting style. Furthermore, the editing unit may edit good videos based on the photographer's past shooting history. For example, the editing unit may preferentially edit photos and videos taken by a specific photographer to create a good video. By considering attribute information of the photographer, editing accuracy is improved. Some or all of the above-described processing in the editing unit may be performed using AI or without using AI. For example, the editing unit may perform editing using an AI model that considers attribute information of the photographer. Specifically, the editing unit receives, as input, metadata of photos and videos (photographer ID, age, gender, years of shooting experience, past shooting history, shooting style feature vector, etc.) and image/video tensors (224×224×3, 64 frames×224×224×3). The editing unit refers to the past shooting history database for each photographer ID and extracts shooting style features (e.g., composition tendency, exposure settings, subject selection tendency, etc.). In addition to convolutional neural networks and Transformer-based image judgment models, the editing unit inputs photographer attribute vectors (e.g., age: 35, gender: 1, experience: 5 years, style: “portrait-oriented”, etc.) and optimizes editing sequence determination algorithms and effect application criteria for each photographer. For example, for beginner photographers, simple editing and automatic correction are frequently used, while for experienced photographers, editing criteria emphasizing artistry and uniqueness are adopted. Examples of AI input include photographer ID (56789), age (35), gender (1), years of experience (5), shooting style vector ([0.8, 0.1, 0.1]), and image tensor (224×224×3). Examples of AI output include editing sequence (order of photo IDs and video IDs), effect application list (auto-correction, art filter, etc.), photographer adaptation score (high), and editing criteria parameters (artistry emphasis). In subsequent processing, the editing unit automatically executes video editing according to editing criteria adapted to photographer attributes and generates the final video file. As a technical effect, the editing unit achieves improved editing accuracy, reduced erroneous editing, and enhanced user satisfaction by multidimensional feature analysis and automatic optimization of editing criteria based on photographer attributes, history, and style, without relying on subjective human evaluation or manual criteria changes. Application fields include family album video generation, school event digest creation, corporate event promotion videos, automatic video editing for tourism customers, and short movie generation for SNS posting. Furthermore, by individual optimization for each photographer, the editing unit can flexibly respond to diverse user needs compared to conventional uniform editing methods.

The registration unit is capable of estimating a user's emotion and adjusting the method of registering face data based on the estimated emotion. For example, the registration unit estimates the user's emotion and adjusts the face data registration method according to the estimated emotion. For instance, if the user is feeling stressed, a simple interface is provided and the registration procedure is minimized. If the user is relaxed, detailed registration options are provided and customizable registration methods may be proposed. Furthermore, if the user is in a hurry, voice input is prioritized to enable quick registration of face data. By adjusting the registration method according to the user's emotion, the user's burden is reduced. Emotion estimation is realized, for example, by using an emotion engine or an emotion estimation function utilizing generative AI. Generative AI may include, for example, text generation AI (such as LLM) or multimodal generative AI, but is not limited to these examples. Some or all of the above-described processing in the registration unit may be performed using AI or without using AI. For example, the registration unit may perform registration using an AI model that estimates the user's emotion and adjusts the face data registration method based on the emotion. Specifically, the registration unit receives, as input, user voice data (e.g., 5 seconds of audio waveform), face images (128×128×3), text input (e.g., “I am in a hurry now”), and biometric sensor values (heart rate, skin conductance, etc.). The registration unit uses a voice emotion recognition model (e.g., acoustic feature extraction+RNN), a facial expression recognition model (e.g., CNN+expression classification), and a text emotion analysis model (e.g., large language model) to calculate emotion scores for each modality (e.g., stress level 0.8, relaxation level 0.2, urgency level 0.7, etc.). The registration unit integrates these emotion scores with weights and determines a final user emotion label (e.g., stress, relaxation, hurry). According to the emotion label, the registration unit dynamically changes the display items of the registration interface, the number of registration steps, and the input method (e.g., voice input, image upload, detailed settings). For example, in a stress state, only the minimum input items are displayed, and one-click registration or automatic face cropping is prioritized. In a relaxed state, options such as detailed face feature vector settings, tagging, and multiple face registration are additionally displayed. In a hurry state, registration by voice command and high-speed face recognition mode are enabled. Examples of AI input include audio waveform (16 kHz, 5 seconds), face image (128×128×3), text (“I am in a hurry now”), and biometric sensor value (heart rate 90 bpm). Examples of AI output include emotion label (hurry), recommended registration interface (voice input prioritized), number of registration steps (1 step), and registration option list (detailed settings hidden). In subsequent processing, the registration unit automatically switches the user interface according to the emotion label and recommended interface, optimizing the user experience. As a technical effect, the registration unit achieves improved registration efficiency, reduced user burden, and enhanced situational adaptability by multimodal emotion estimation and automatic registration procedure control, without relying on subjective human judgment or manual interface switching. Application fields include family album management, school event records, corporate employee face databases, customer face registration in the tourism industry, and SNS-linked face search services. Furthermore, by linking emotion estimation AI and registration interface control AI, the registration unit realizes flexible optimization of registration criteria according to the user's state, achieving a significant improvement in user experience compared to conventional uniform registration methods.

The registration unit can optimize the registration algorithm by referring to past registration data during registration. Past registration data may include, for example, registration date and time, registered face features, and number of registrations, but is not limited thereto. For example, the registration unit may propose an optimal registration algorithm based on face data previously registered by the user. The registration unit may also propose an optimal registration method for a specific time period based on the user's past registration history. Furthermore, the registration unit may select an optimal registration algorithm based on devices previously used by the user. For example, the registration unit may propose an optimal registration algorithm based on face data previously registered by the user. By referring to past registration data, the accuracy of the registration algorithm is improved. Some or all of the above-described processing in the registration unit may be performed using AI or without using AI. For example, the registration unit may perform registration using an AI model that optimizes the registration algorithm by referring to past registration data. Specifically, the registration unit receives, as input, a user-specific registration history database (e.g., a structured table including registration date and time timestamp, face feature vector, registration method ID, device ID, registration success/failure flag, etc.). The registration unit preprocesses these history data as time-series vectors (e.g., vectorizing each registration event and treating the most recent 100 events as one series), and applies time-series analysis models (e.g., LSTM or Transformer Encoder) to extract selection tendencies for registration methods and success rate patterns for each time period. The registration unit calculates multiple features such as usage frequency distribution for each registration method, registration success rate for each day of the week and time period, and registration stability score for each device, and integrates these with weights to generate a “registration method recommendation score.” Examples of AI input include registration history vectors (e.g., 100 events×8 dimensions), registration method categories (Web, mobile, voice, etc.), device ID (integer value), and registration time (UNIX timestamp). Examples of AI output include registration method recommendation score (Web: 0.92, mobile: 0.85, voice: 0.60, etc.), recommended registration method label (Web), and recommended reason text (“Web registration had the highest success rate in the past 30 days,” etc.). In subsequent processing, the registration unit preferentially displays the registration method with the highest recommendation score on the user interface, allowing the user to select it with one click. As a technical effect, the registration unit achieves optimization of registration methods, reduction of registration failure rate, and reduction of user operation burden by high-dimensional feature extraction and time-series pattern analysis of history data, without relying on human memory or heuristics. Application fields include family album management, corporate employee face databases, customer face registration in the tourism industry, school event face registration, and SNS-linked face search services. Furthermore, the registration unit can realize more advanced registration optimization functions by statistically analyzing the history of multiple users, recommending by user type through clustering, and detecting special patterns during seasonal changes or events.

The search unit is capable of estimating a user's emotion and adjusting the display method of search results based on the estimated emotion. For example, the search unit estimates the user's emotion and adjusts the display method of search results according to the estimated emotion. For instance, if the user is feeling stressed, important search results are displayed first to reduce the user's burden. If the user is relaxed, all search results may be displayed equally. Furthermore, if the user is in a hurry, the most important search results may be displayed with the highest priority. By adjusting the display method of search results according to the user's emotion, the user's burden is reduced. Emotion estimation is realized, for example, by using an emotion engine or an emotion estimation function utilizing generative AI. Generative AI may include, for example, text generation AI (such as LLM) or multimodal generative AI, but is not limited to these examples. Some or all of the above-described processing in the search unit may be performed using AI or without using AI. For example, the search unit may perform searching using an AI model that estimates the user's emotion and adjusts the display method of search results based on the emotion. Specifically, the search unit receives, as input, user voice data (e.g., 5 seconds of audio waveform), face images (128×128×3), text input (e.g., “I am in a hurry now”), and biometric sensor values (heart rate, skin conductance, etc.), among other multimodal data. The search unit uses a voice emotion recognition model (e.g., acoustic feature extraction+RNN), a facial expression recognition model (e.g., CNN+expression classification), and a text emotion analysis model (e.g., large language model) to calculate emotion scores for each modality (e.g., stress level 0.8, relaxation level 0.2, urgency level 0.7, etc.). The search unit integrates these emotion scores with weights and determines a final user emotion label (e.g., stress, relaxation, hurry). The search unit receives search queries (e.g., natural language text such as “photo of ○○ at age 5”), face photos (128×128×3), face ID, age specification, shooting date and time, and other search conditions as input, extracts face feature vectors using face detection and recognition models, and compares them with face feature vectors in the database using cosine similarity or Euclidean distance. Furthermore, the search unit uses approximate nearest neighbor search engines such as Annoy or FAISS to quickly extract relevant photos or videos from tens of thousands to millions of face feature vectors. Examples of AI input include audio waveform (16 kHz, 5 seconds), face image (128×128×3), text (“I am in a hurry now”), biometric sensor value (heart rate 90 bpm), search query (“photo of ○○ at age 5”), face ID (12345), and age specification (5). Examples of AI output include emotion label (hurry), search result list (photo ID array [101, 102, 103]), search result scores (0.92, 0.88, 0.85), display priority list (data ID: priority), and recommended display order (e.g., Data A→Data B→Data C). According to the emotion label, the search unit dynamically changes display parameters such as search result order, emphasis, thumbnail size, and simplification/detailing of descriptions. For example, in a stress state, only search results with high importance scores are displayed prominently, and other results are collapsed. In a relaxed state, all results are displayed equally, allowing the user to freely select. In a hurry state, only the most important result is displayed immediately, and detailed explanations are omitted. In subsequent processing, the search unit automatically adjusts display parameters on the user interface, enabling the user to efficiently select desired photos or videos. As a technical effect, the search unit achieves improved search experience, reduced user burden, and enhanced situational adaptability by multimodal emotion estimation and automatic display control, without relying on subjective human judgment or manual display switching. Application fields include family album management, school event records, corporate employee search, customer photo search in the tourism industry, and SNS-linked face search services. Furthermore, by linking emotion estimation AI and search result display control AI, the search unit realizes flexible optimization of display criteria according to the user's state, achieving a significant improvement in user experience compared to conventional uniform display methods.

The search unit can select an optimal search algorithm by referring to past search history during searching. Past search history may include, for example, search date and time, search keywords, and number of clicks on search results, but is not limited thereto. For example, the search unit may propose an optimal search algorithm based on keywords previously searched by the user. The search unit may also propose an optimal search method for a specific time period based on the user's past search history. Furthermore, the search unit may select an optimal search algorithm based on devices previously used by the user. For example, the search unit may propose an optimal search algorithm based on keywords previously searched by the user. By referring to past search history, the optimal search algorithm can be provided. Some or all of the above-described processing in the search unit may be performed using AI or without using AI. For example, the search unit may perform searching using an AI model that selects an optimal search algorithm by referring to past search history. Specifically, the search unit receives, as input, a user-specific search history database (e.g., a structured table including search date and time timestamp, search keywords, number of clicks on search results, search method ID, device ID, search success/failure flag, etc.). The search unit preprocesses these history data as time-series vectors (e.g., vectorizing each search event and treating the most recent 100 events as one series), and applies time-series analysis models (e.g., LSTM or Transformer Encoder) to extract selection tendencies for search methods and usage patterns for each time period. The search unit calculates multiple features such as usage frequency distribution for each search method, search success rate for each day of the week and time period, and search stability score for each device, and integrates these with weights to generate a “search method recommendation score.” Examples of AI input include search history vectors (e.g., 100 events×8 dimensions), search method categories (face search, text search, tag search, etc.), device ID (integer value), and search time (UNIX timestamp). Examples of AI output include search method recommendation score (face search: 0.92, text search: 0.85, tag search: 0.60, etc.), recommended search method label (face search), and recommended reason text (“Face search had the highest success rate in the past 30 days,” etc.). In subsequent processing, the search unit preferentially displays the search method with the highest recommendation score on the user interface, allowing the user to select it with one click. As a technical effect, the search unit achieves optimization of search methods, reduction of search failure rate, and reduction of user operation burden by high-dimensional feature extraction and time-series pattern analysis of history data, without relying on human memory or heuristics. Application fields include family album management, corporate employee face databases, customer photo search in the tourism industry, school event photo search, and SNS-linked face search services. Furthermore, the search unit can realize more advanced search optimization functions by statistically analyzing the history of multiple users, recommending by user type through clustering, and detecting special patterns during seasonal changes or events.

The search unit is capable of estimating a user's emotion and determining the priority of search results based on the estimated emotion. For example, the search unit estimates the user's emotion and determines the priority of search results according to the estimated emotion. For instance, if the user is feeling stressed, important search results are displayed first to reduce the user's burden. If the user is relaxed, all search results may be displayed equally. Furthermore, if the user is in a hurry, the most important search results may be displayed with the highest priority. By determining the priority of search results according to the user's emotion, important search results can be preferentially displayed. Emotion estimation is realized, for example, by using an emotion engine or an emotion estimation function utilizing generative AI. Generative AI may include, for example, text generation AI (such as LLM) or multimodal generative AI, but is not limited to these examples. Some or all of the above-described processing in the search unit may be performed using AI or without using AI. For example, the search unit may perform searching using an AI model that estimates the user's emotion and determines the priority of search results based on the emotion. Specifically, the search unit receives, as input, user voice data (e.g., 5 seconds of audio waveform), face images (128×128×3), text input (e.g., “I am very stressed now”), and biometric sensor values (heart rate, skin conductance, etc.), among other multimodal data. The search unit uses a voice emotion recognition model (e.g., acoustic feature extraction+RNN), a facial expression recognition model (e.g., CNN+expression classification), and a text emotion analysis model (e.g., large language model) to calculate emotion scores for each modality (e.g., stress level 0.8, relaxation level 0.2, urgency level 0.7, etc.). The search unit integrates these emotion scores with weights and determines a final user emotion label (e.g., stress, relaxation, hurry). The search unit receives search queries, face photos, face ID, age specification, shooting date and time, and other search conditions as input, extracts face feature vectors using face detection and recognition models, and compares them with face feature vectors in the database using cosine similarity or Euclidean distance. Furthermore, the search unit uses approximate nearest neighbor search engines such as Annoy or FAISS to quickly extract relevant photos or videos from tens of thousands to millions of face feature vectors. Examples of AI input include audio waveform (16 kHz, 5 seconds), face image (128×128×3), text (“I am very stressed now”), biometric sensor value (heart rate 85 bpm), search query (“photo of ○○ at age 5”), face ID (12345), and age specification (5). Examples of AI output include emotion label (stress), search result list (photo ID array [101, 102, 103]), search result scores (0.92, 0.88, 0.85), priority list (data ID: priority), and recommended display order (e.g., Data A→Data B→Data C). According to the emotion label, the search unit dynamically changes display parameters such as search result priority, emphasis, thumbnail size, and simplification/detailing of descriptions. For example, in a stress state, only search results with high importance scores are displayed prominently, and other results are collapsed. In a relaxed state, all results are displayed equally, allowing the user to freely select. In a hurry state, only the most important result is displayed immediately, and detailed explanations are omitted. In subsequent processing, the search unit automatically adjusts display parameters on the user interface, enabling the user to efficiently select desired photos or videos. As a technical effect, the search unit achieves improved search experience, prevention of missing important data, and reduced user burden by multimodal emotion estimation and automatic priority control, without relying on subjective human judgment or manual prioritization. Application fields include family album management, school event records, corporate employee search, customer photo search in the tourism industry, and SNS-linked face search services. Furthermore, by linking emotion estimation AI and search result priority control AI, the search unit realizes flexible optimization of priority according to the user's state, achieving a significant improvement in user experience compared to conventional uniform display methods.

The search unit can provide optimal search results by considering the user's device information during searching. Device information may include, for example, device type, OS, and screen size, but is not limited thereto. For example, if the user is using a smartphone, the search unit provides search results optimized for the screen size. If the user is using a tablet, the search unit can provide search results optimized for a larger screen. Furthermore, if the user is using a smartwatch, the search unit can provide concise and highly visible search results. By considering device information, optimal search results can be provided. Some or all of the above-described processing in the search unit may be performed using AI or without using AI. For example, the search unit may perform searching using an AI model that considers device information to provide optimal search results. Specifically, the search unit receives, as input, device information obtained from the user terminal (e.g., device type label, OS version, screen resolution, screen size, input method, network bandwidth, etc.) and search query (e.g., “family photos,” etc.). The search unit preprocesses device information as categorical or numerical vectors and generates parameters for optimizing display layout, image thumbnail size, description length, and interaction method (tap, swipe, voice input, etc.) according to screen size and resolution. As an AI model, a device-adaptive display control model (e.g., multilayer perceptron or gradient boosting model) is used to determine the display method that maximizes user experience. Examples of AI input include device type (smartphone, tablet, smartwatch, etc.), screen resolution (1080×1920, etc.), OS version (Android 12, etc.), network bandwidth (10 Mbps, etc.), and search query (“family photos”). Examples of AI output include recommended display layout (grid, list, etc.), thumbnail size (small, medium, large), description length (short, medium, long), and interaction method (tap, voice, etc.). In subsequent processing, the search unit automatically adjusts the user interface according to the display parameters output by the AI, enabling the user to view and select search results optimized for the device environment. As a technical effect, the search unit achieves improved search experience, reduced erroneous operations, and reduced user burden by automatic analysis of device information and display optimization, without relying on subjective human judgment or manual layout switching. Application fields include family album management, corporate employee search, customer photo search in the tourism industry, school event photo search, and SNS-linked face search services. Furthermore, the search unit can realize more advanced device adaptation functions, such as seamless search experience across multiple devices and image compression/delay control according to network bandwidth.

The system according to the embodiment is not limited to the above-described examples and can be variously modified as follows. Specifically, the system can flexibly combine neural network architectures (e.g., ResNet, Transformer, RNN, etc.), learning methods (e.g., transfer learning, self-supervised learning, online learning, etc.), feature design (e.g., face feature vectors, composition scores, time-series patterns, etc.), data flow (e.g., image tensors, metadata, time-series vectors, etc.), and subsequent processing (e.g., threshold judgment, ranking, clustering, etc.) in each unit such as face recognition, emotion estimation, search, extraction, editing, and registration. The system can also dynamically switch AI model input/output specifications and parameters according to user attributes, usage environment, and purpose, and can be applied to various fields such as corporate employee management, customer service in the tourism industry, school event records, and SNS-linked automatic editing/search services, in addition to family album management. Furthermore, the system can implement extended functions such as cooperation among multiple AI modules (e.g., emotion estimation AI+face recognition AI+search AI), distributed processing infrastructure (e.g., GPU cluster, edge device cooperation), enhanced security (e.g., anonymization of face data, access control), automatic model updating by user feedback, anomaly detection, and trend detection. As a result, the system functions as a platform with superior flexibility, scalability, and technological evolvability compared to conventional single-function systems, and achieves significant improvements in user experience, operational efficiency, and data management accuracy.

The receiving unit can analyze a user's past data reception history and select an optimal reception method. For example, the receiving unit preferentially proposes reception methods frequently used by the user in the past (e.g., via Wi-Fi or USB connection). The receiving unit may also propose an optimal reception method for a specific time period based on the user's past reception history. Furthermore, the receiving unit may select an optimal reception method based on devices previously used by the user. By analyzing past data reception history, the optimal reception method can be provided. Specifically, the receiving unit receives, as input, a user-specific reception history database (e.g., a structured table including reception date and time timestamp, data type label, reception method ID, device ID, reception success/failure flag, etc.). The receiving unit preprocesses these history data as time-series vectors (e.g., vectorizing each reception event and treating the most recent 100 events as one series), and applies time-series analysis models (e.g., LSTM or Transformer Encoder) to extract selection tendencies for reception methods and usage patterns for each time period. The receiving unit calculates multiple features such as usage frequency distribution for each reception method, reception success rate for each day of the week and time period, and connection stability score for each device, and integrates these with weights to generate a “reception method recommendation score.” Examples of AI input include reception history vectors (e.g., 100 events×8 dimensions), reception method categories (Wi-Fi, USB, Bluetooth, etc.), device ID (integer value), and reception time (UNIX timestamp). Examples of AI output include reception method recommendation score (Wi-Fi: 0.92, USB: 0.85, Bluetooth: 0.60, etc.), recommended reception method label (Wi-Fi), and recommended reason text (“Wi-Fi had the highest reception success rate in the past 30 days,” etc.). In subsequent processing, the receiving unit preferentially displays the reception method with the highest recommendation score on the user interface, allowing the user to select it with one click. As a technical effect, the receiving unit achieves optimization of reception methods, reduction of reception failure rate, and reduction of user operation burden by high-dimensional feature extraction and time-series pattern analysis of history data, without relying on human memory or heuristics. Application fields include family album management systems, corporate data collection terminals, customer data reception in the tourism industry, photo reception for school events, and SNS-linked automatic reception services. Furthermore, the receiving unit can realize more advanced reception optimization functions by statistically analyzing the history of multiple users, recommending by user type through clustering, and detecting special patterns during seasonal changes or events.

The detection unit is capable of estimating a user's emotion and adjusting the criteria for detecting duplicate photos or erroneous photos based on the estimated emotion. For example, if the user is feeling stressed, the detection unit applies strict criteria to detect duplicate photos or erroneous photos, thereby reducing the user's burden. If the user is relaxed, the detection unit applies lenient criteria, providing the user with more options. Furthermore, if the user is in a hurry, the detection unit performs rapid detection, retaining only important photos. By adjusting the detection criteria according to the user's emotion, the user's burden is reduced. Specifically, the detection unit receives, as input, user voice data (e.g., 5 seconds of audio waveform), face images (128×128×3), text input (e.g., “I am busy now”), and biometric sensor values (heart rate, skin conductance, etc.). The detection unit uses a voice emotion recognition model (e.g., acoustic feature extraction+RNN), a facial expression recognition model (e.g., CNN+expression classification), and a text emotion analysis model (e.g., large language model) to calculate emotion scores for each modality (e.g., stress level 0.8, relaxation level 0.2, urgency level 0.7, etc.). The detection unit integrates these emotion scores with weights and determines a final user emotion label (e.g., stress, relaxation, hurry). The detection unit processes image tensors received from the receiving unit (e.g., 224×224×3 RGB images, or 64 frames×224×224×3 spatiotemporal tensors for videos) as input data, and uses image judgment models equipped with convolutional neural networks and self-attention mechanisms to calculate duplicate score (cosine similarity or feature vector distance) and erroneous photo judgment score (backlit degree, out-of-focus degree, brightness histogram of face region, etc.). The detection unit dynamically changes the thresholds for duplicate score and erroneous photo judgment score according to the user emotion label. For example, in a stress state, the duplicate threshold is set to 0.85, and more duplicate photos or erroneous photos are eliminated. In a relaxed state, the threshold is relaxed to 0.95, leaving more options for the user. In a hurry state, only images with high quality scores are retained, and the detection process itself is executed in high-speed mode. Examples of AI input include audio waveform (16 kHz, 5 seconds), face image (128×128×3), text (“I am busy now”), biometric sensor value (heart rate 80 bpm), and image tensor (224×224×3). Examples of AI output include emotion label (stress), duplicate score (0.95), erroneous photo label (1: backlit, 0: normal), and detection threshold (0.85). In subsequent processing, the detection unit automatically judges and eliminates duplicate photos or erroneous photos based on the emotion label and detection threshold, optimizing input data for the extraction unit. As a technical effect, the detection unit achieves improved detection accuracy, reduced user burden, and enhanced situational adaptability by multimodal emotion estimation and automatic threshold control, without relying on subjective human judgment or manual criteria changes. Application fields include family album management, corporate event records, customer photo services in the tourism industry, and SNS-linked automatic album generation. Furthermore, by linking emotion estimation AI and image judgment AI, the detection unit realizes flexible optimization of detection criteria according to the user's state, achieving a significant improvement in user experience compared to conventional uniform judgment methods.

The extraction unit is capable of estimating a user's emotion and adjusting the criteria for extracting good photos based on the estimated emotion. For example, if the user is feeling stressed, the extraction unit applies strict criteria to extract good photos, thereby reducing the user's burden. If the user is relaxed, the extraction unit applies lenient criteria, providing the user with more options. Furthermore, if the user is in a hurry, the extraction unit performs rapid extraction, retaining only important photos. By adjusting the extraction criteria according to the user's emotion, the user's burden is reduced. Specifically, the extraction unit receives, as input, user voice data (e.g., 5 seconds of audio waveform), face images (128×128×3), text input (e.g., “I am busy now”), and biometric sensor values (heart rate, skin conductance, etc.). The extraction unit uses a voice emotion recognition model (e.g., acoustic feature extraction+RNN), a facial expression recognition model (e.g., CNN+expression classification), and a text emotion analysis model (e.g., large language model) to calculate emotion scores for each modality (e.g., stress level 0.8, relaxation level 0.2, urgency level 0.7, etc.). The extraction unit integrates these emotion scores with weights and determines a final user emotion label (e.g., stress, relaxation, hurry). The extraction unit processes image tensors received from the receiving unit or detection unit (e.g., 224×224×3 RGB images, or 64 frames×224×224×3 spatiotemporal tensors for videos) as input data, and uses face detection models (e.g., YOLO-based or MTCNN), face recognition models (ResNet-based or Transformer-based), and composition evaluation models (e.g., rule of thirds score, subject centering, color balance, etc.) to calculate multiple evaluation indices such as face clarity score, composition score, and image quality score. The extraction unit dynamically changes the threshold for good photo score and the weights of evaluation indices according to the user emotion label. For example, in a stress state, the good photo score threshold is set to 0.85, and only carefully selected photos are extracted. In a relaxed state, the threshold is relaxed to 0.75, leaving more photos as candidates. In a hurry state, only photos with high face clarity and composition scores are preferentially extracted, and the process itself is executed in high-speed mode. Examples of AI input include audio waveform (16 kHz, 5 seconds), face image (128×128×3), text (“I am busy now”), biometric sensor value (heart rate 80 bpm), and image tensor (224×224×3). Examples of AI output include emotion label (stress), good photo score (0.87), face clarity score (0.93), extraction threshold (0.85). In subsequent processing, the extraction unit automatically judges and extracts good photos based on the emotion label and extraction threshold, optimizing input data for the editing unit or search unit. As a technical effect, the extraction unit achieves improved extraction accuracy, reduced user burden, and enhanced situational adaptability by multimodal emotion estimation and automatic threshold control, without relying on subjective human judgment or manual criteria changes. Application fields include family album management, corporate event records, customer photo services in the tourism industry, and SNS-linked automatic album generation. Furthermore, by linking emotion estimation AI and face/composition evaluation AI, the extraction unit realizes flexible optimization of extraction criteria according to the user's state, achieving a significant improvement in user experience compared to conventional uniform judgment methods.

The editing unit is capable of estimating a user's emotion and adjusting the video editing method based on the estimated emotion. For example, if the user is relaxed, the editing unit edits a video that progresses at a leisurely pace. If the user is in a hurry, the editing unit can edit a short video that focuses on key points. Furthermore, if the user is excited, the editing unit can edit a video with visually stimulating effects. By adjusting the editing method according to the user's emotion, videos tailored to the user's needs can be provided. Specifically, the editing unit receives, as input, user voice data (e.g., 5 seconds of audio waveform), face images (128×128×3), text input (e.g., “I am excited now”), and biometric sensor values (heart rate, skin conductance, etc.). The editing unit uses a voice emotion recognition model (e.g., acoustic feature extraction+RNN), a facial expression recognition model (e.g., CNN+expression classification), and a text emotion analysis model (e.g., large language model) to calculate emotion scores for each modality (e.g., relaxation level 0.7, excitement level 0.8, urgency level 0.6, etc.). The editing unit integrates these emotion scores with weights and determines a final user emotion label (e.g., relaxed, excited, hurried). The editing unit processes metadata of photos and videos received from the extraction unit (e.g., shooting date and time, face ID, composition score, event tag, etc.) and image/video tensors (e.g., 224×224×3, 64 frames×224×224×3) as input data. The editing unit dynamically changes the parameters of the editing sequence determination algorithm (e.g., reinforcement learning, beam search, rule-based) and effect application algorithm according to the user emotion label. For example, in a relaxed state, the scene transition interval is lengthened, a leisurely BGM is selected, and transition effects are mainly set to fade. In a hurried state, only important scenes are extracted, the entire video is shortened, and fast-tempo BGM and cut-in/cut-out effects are frequently used. In an excited state, color correction, zoom, slow motion, dynamic transitions, and effects (e.g., flash, particles) are automatically applied. Examples of AI input include audio waveform (16 kHz, 5 seconds), face image (128×128×3), text (“I am excited now”), biometric sensor value (heart rate 90 bpm), photo ID list output from the extraction unit ([101, 102, 103]), metadata for each photo (face ID: 123, composition score: 0.88, shooting date and time: 2023 Aug. 1 10:00, etc.), and video clips (64 frames×224×224×3). Examples of AI output include emotion label (excited), editing sequence (order of photo IDs and video IDs), display time for each scene (e.g., photo 101: 3 seconds, video 201: 7 seconds), applied effect list (zoom-in, BGM: up-tempo music, color correction: vivid, etc.), and final video file (MP4 format). In subsequent processing, the editing unit executes video rendering processing using a parallel computation cluster with GPUs according to the editing sequence output by the AI, and generates the final video file. As a technical effect, the editing unit achieves optimized video generation, improved editing efficiency, and enhanced user satisfaction according to the user's state by multimodal emotion estimation and automatic editing parameter control, without relying on subjective human editing work or manual effect application. Application fields include family album video generation, school event digest creation, corporate event promotion videos, automatic video editing for tourism customers, and short movie generation for SNS posting. Furthermore, by linking emotion estimation AI and editing AI, the editing unit realizes flexible optimization of editing criteria according to the user's state, achieving a significant improvement in user experience compared to conventional uniform editing methods.

The registration unit is capable of estimating a user's emotion and adjusting the method of registering face data based on the estimated emotion. For example, if the user is feeling stressed, a simple interface is provided and the registration procedure is minimized. If the user is relaxed, detailed registration options are provided and customizable registration methods may be proposed. Furthermore, if the user is in a hurry, voice input is prioritized to enable quick registration of face data. By adjusting the registration method according to the user's emotion, the user's burden is reduced. Specifically, the registration unit receives, as input, user voice data (e.g., 5 seconds of audio waveform), face images (128×128×3), text input (e.g., “I am in a hurry now”), and biometric sensor values (heart rate, skin conductance, etc.). The registration unit uses a voice emotion recognition model (e.g., acoustic feature extraction+RNN), a facial expression recognition model (e.g., CNN+expression classification), and a text emotion analysis model (e.g., large language model) to calculate emotion scores for each modality (e.g., stress level 0.8, relaxation level 0.2, urgency level 0.7, etc.). The registration unit integrates these emotion scores with weights and determines a final user emotion label (e.g., stress, relaxation, hurry). According to the emotion label, the registration unit dynamically changes the display items of the registration interface, the number of registration steps, and the input method (e.g., voice input, image upload, detailed settings). For example, in a stress state, only the minimum input items are displayed, and one-click registration or automatic face cropping is prioritized. In a relaxed state, options such as detailed face feature vector settings, tagging, and multiple face registration are additionally displayed. In a hurry state, registration by voice command and high-speed face recognition mode are enabled. Examples of AI input include audio waveform (16 kHz, 5 seconds), face image (128×128×3), text (“I am in a hurry now”), and biometric sensor value (heart rate 90 bpm). Examples of AI output include emotion label (hurry), recommended registration interface (voice input prioritized), number of registration steps (1 step), and registration option list (detailed settings hidden). In subsequent processing, the registration unit automatically switches the user interface according to the emotion label and recommended interface, optimizing the user experience. As a technical effect, the registration unit achieves improved registration efficiency, reduced user burden, and enhanced situational adaptability by multimodal emotion estimation and automatic registration procedure control, without relying on subjective human judgment or manual interface switching. Application fields include family album management, school event records, corporate employee face databases, customer face registration in the tourism industry, and SNS-linked face search services. Furthermore, by linking emotion estimation AI and registration interface control AI, the registration unit realizes flexible optimization of registration criteria according to the user's state, achieving a significant improvement in user experience compared to conventional uniform registration methods.

The search unit is capable of estimating a user's emotion and adjusting the display method of search results based on the estimated emotion. For example, if the user is feeling stressed, important search results are displayed first to reduce the user's burden. If the user is relaxed, all search results may be displayed equally. Furthermore, if the user is in a hurry, the most important search results may be displayed with the highest priority. By adjusting the display method of search results according to the user's emotion, the user's burden is reduced. Specifically, the search unit receives, as input, user voice data (e.g., 5 seconds of audio waveform), face images (128×128×3), text input (e.g., “I am in a hurry now”), and biometric sensor values (heart rate, skin conductance, etc.), among other multimodal data. The search unit uses a voice emotion recognition model (e.g., acoustic feature extraction+RNN), a facial expression recognition model (e.g., CNN+expression classification), and a text emotion analysis model (e.g., large language model) to calculate emotion scores for each modality (e.g., stress level 0.8, relaxation level 0.2, urgency level 0.7, etc.). The search unit integrates these emotion scores with weights and determines a final user emotion label (e.g., stress, relaxation, hurry). The search unit receives search queries (e.g., natural language text such as “photo of ○○ at age 5”), face photos (128×128×3), face ID, age specification, shooting date and time, and other search conditions as input, extracts face feature vectors using face detection and recognition models, and compares them with face feature vectors in the database using cosine similarity or Euclidean distance. Furthermore, the search unit uses approximate nearest neighbor search engines such as Annoy or FAISS to quickly extract relevant photos or videos from tens of thousands to millions of face feature vectors. Examples of AI input include audio waveform (16 kHz, 5 seconds), face image (128×128×3), text (“I am in a hurry now”), biometric sensor value (heart rate 90 bpm), search query (“photo of ○○ at age 5”), face ID (12345), and age specification (5). Examples of AI output include emotion label (hurry), search result list (photo ID array [101, 102, 103]), search result scores (0.92, 0.88, 0.85), display priority list (data ID: priority), and recommended display order (e.g., Data A→Data B→Data C). According to the emotion label, the search unit dynamically changes display parameters such as search result order, emphasis, thumbnail size, and simplification/detailing of descriptions. For example, in a stress state, only search results with high importance scores are displayed prominently, and other results are collapsed. In a relaxed state, all results are displayed equally, allowing the user to freely select. In a hurry state, only the most important result is displayed immediately, and detailed explanations are omitted. In subsequent processing, the search unit automatically adjusts display parameters on the user interface, enabling the user to efficiently select desired photos or videos. As a technical effect, the search unit achieves improved search experience, reduced user burden, and enhanced situational adaptability by multimodal emotion estimation and automatic display control, without relying on subjective human judgment or manual display switching. Application fields include family album management, school event records, corporate employee search, customer photo search in the tourism industry, and SNS-linked face search services. Furthermore, by linking emotion estimation AI and search result display control AI, the search unit realizes flexible optimization of display criteria according to the user's state, achieving a significant improvement in user experience compared to conventional uniform display methods.

The receiving unit can consider a user's geographic location information at the time of data reception and preferentially receive highly relevant data. For example, if the user is traveling, the receiving unit preferentially receives photo or video data related to the travel destination based on geographic location information. If the user is at home, the receiving unit can preferentially receive data taken around the home. Furthermore, if the user is participating in a specific event, the receiving unit can preferentially receive data related to that event. By considering geographic location information, highly relevant data can be preferentially received. Specifically, the receiving unit receives, as input, GPS coordinates (latitude and longitude) obtained from the user terminal, location ID from location information services, current event information (e.g., event name, venue, event time), and shooting location metadata of the data to be received (e.g., photo/video shooting coordinates, location tag). The receiving unit calculates the spatial distance between the current location and the shooting location of the data to be received, assigning a higher relevance score to data with a shorter distance. Furthermore, the receiving unit calculates event relevance scores based on event information and location tag matches. As an AI model, spatial distance calculation+rule-based scoring or a gradient boosting model using geographic features as input can be used. Examples of AI input include current location coordinates (35.6895, 139.6917), reception data shooting coordinates (35.6900, 139.6920), location tag (“Tokyo Station”, “Home”, etc.), and event ID (12345). Examples of AI output include reception relevance score (0.98: travel destination photo, 0.85: home photo, etc.), reception priority list (data ID: priority), and recommended reception data label (“event-related”, etc.). In subsequent processing, the receiving unit displays the data with high relevance scores at the top of the reception candidate list, enabling the user to efficiently select relevant data. As a technical effect, the receiving unit achieves improved reception efficiency, prevention of missing relevant data, and reduced user burden by automatic analysis of geographic features and spatial matching, without relying on subjective human judgment or manual location specification. Application fields include family album management, customer data reception in the tourism industry, event records, school event records, and SNS-linked automatic reception services. Furthermore, the receiving unit can also analyze spatiotemporal patterns such as travel routes and stay duration, realizing reception optimization based on the user's behavioral history.

The detection unit can improve detection accuracy by considering interrelationships among photos and videos during detection. For example, the detection unit groups photos and videos taken at the same event and detects duplicate photos considering their interrelationships. The detection unit may also detect erroneous photos based on the shooting date and time of photos and videos, taking interrelationships into account. Furthermore, the detection unit can analyze the content of photos and videos and improve detection accuracy by considering interrelationships. By considering interrelationships among photos and videos, detection accuracy is improved. Specifically, the detection unit receives, as input, metadata of photos and videos received from the receiving unit (e.g., shooting date and time timestamp, shooting location GPS coordinates, event ID, subject tag, face ID list, photographer ID, etc.) and image/video tensors (e.g., 224×224×3, 64 frames×224×224×3). The detection unit first applies time-series clustering (e.g., DBSCAN or time-series K-means) and spatial clustering (e.g., spatial grouping using Haversine distance) based on metadata to automatically generate same-event or closely shot groups. For images and videos within a group, the detection unit generates high-dimensional feature vectors (e.g., 512 dimensions) using convolutional neural networks or Transformer-based feature extraction models, and calculates duplicate scores using cosine similarity or Euclidean distance. Furthermore, the detection unit integrates multiple interrelationship features such as subject tag and face ID match, proximity of shooting date and time, and spatial distance of shooting location with weights, and dynamically adjusts thresholds for duplicate judgment and erroneous photo judgment. Examples of AI input include shooting date and time (2023 Aug. 1 10:00), shooting location (35.6895, 139.6917), event ID (12345), face ID list (101, 102), and image tensor (224×224×3). Examples of AI output include group ID (1: Event A), duplicate score (0.97), erroneous photo label (1: backlit, 0: normal), and detection priority (high). In subsequent processing, the detection unit automatically judges and eliminates duplicate photos or erroneous photos for each group, optimizing input data for the extraction unit. As a technical effect, the detection unit achieves improved detection accuracy, reduced erroneous judgment, and increased processing efficiency by multidimensional feature analysis integrating spatiotemporal, subject, and event information, without relying on subjective human grouping or manual judgment. Application fields include family album management, school event records, corporate event records, customer photo services in the tourism industry, and SNS-linked automatic album generation. Furthermore, the detection unit enables flexible grouping and judgment by event or photographer unit, achieving significant improvement in accuracy and user experience compared to conventional single-image judgment methods.

The extraction unit can perform extraction by considering attribute information of the photographer of photos and videos during extraction. For example, the extraction unit may preferentially extract photos and videos taken by a specific photographer to select good photos. The extraction unit may also adjust the criteria for extracting good photos by considering the photographer's shooting style. Furthermore, the extraction unit may extract good photos based on the photographer's past shooting history. By considering attribute information of the photographer, extraction accuracy is improved. Specifically, the extraction unit receives, as input, metadata of photos and videos (photographer ID, age, gender, years of shooting experience, past shooting history, shooting style feature vector, etc.) and image/video tensors (224×224×3, 64 frames×224×224×3). The extraction unit refers to the past shooting history database for each photographer ID and extracts shooting style features (e.g., composition tendency, exposure settings, subject selection tendency, etc.). The extraction unit uses face detection models (YOLO-based or MTCNN), face recognition models (ResNet-based or Transformer-based), and composition evaluation models (e.g., rule of thirds score, subject centering, color balance, etc.), and inputs photographer attribute vectors (e.g., age: 35, gender: 1, experience: 5 years, style: “portrait-oriented”, etc.) to optimize the threshold for good photo score and the weights of evaluation indices for each photographer. For example, for beginner photographers, face clarity and composition scores are emphasized, while for experienced photographers, judgment criteria emphasizing artistry and uniqueness are adopted. Examples of AI input include photographer ID (56789), age (35), gender (1), years of experience (5), shooting style vector (0.8, 0.1, 0.1), and image tensor (224×224×3). Examples of AI output include good photo score (0.93), face clarity score (0.95), composition score (0.90), extraction threshold (0.90), and photographer adaptation score (high). In subsequent processing, the extraction unit automatically judges and extracts good photos according to judgment criteria adapted to photographer attributes, optimizing input data for the editing unit or search unit. As a technical effect, the extraction unit achieves improved extraction accuracy, reduced erroneous judgment, and enhanced user satisfaction by multidimensional feature analysis and automatic optimization of judgment criteria based on photographer attributes, history, and style, without relying on subjective human evaluation or manual criteria changes. Application fields include family album management, school event records, corporate event records, customer photo services in the tourism industry, and SNS-linked automatic album generation. Furthermore, by individual optimization for each photographer, the extraction unit can flexibly respond to diverse user needs compared to conventional uniform judgment methods.

The editing unit can improve editing accuracy by considering interrelationships among photos and videos during editing. For example, the editing unit groups photos and videos taken at the same event and edits them considering their interrelationships. The editing unit may also edit based on the shooting date and time of photos and videos, taking interrelationships into account. Furthermore, the editing unit can analyze the content of photos and videos and improve editing accuracy by considering interrelationships. By considering interrelationships among photos and videos, editing accuracy is improved. Specifically, the editing unit receives, as input, metadata of photos and videos received from the receiving unit or extraction unit (shooting date and time timestamp, shooting location GPS coordinates, event ID, subject tag, face ID list, photographer ID, etc.) and image/video tensors (224×224×3, 64 frames×224×224×3). The editing unit first applies time-series clustering (e.g., DBSCAN or time-series K-means) and spatial clustering (e.g., spatial grouping using Haversine distance) based on metadata to automatically generate same-event or closely shot groups. For images and videos within a group, the editing unit generates high-dimensional feature vectors (e.g., 512 dimensions) using convolutional neural networks or Transformer-based feature extraction models, and calculates content similarity scores using cosine similarity or Euclidean distance. Furthermore, the editing unit integrates multiple interrelationship features such as subject tag and face ID match, proximity of shooting date and time, and spatial distance of shooting location with weights, and inputs them into the editing sequence determination algorithm (e.g., reinforcement learning, beam search). For example, within the same event group, the editing unit determines the order emphasizing story and chronological flow, and optimizes scene transitions and effect application on a group basis. Examples of AI input include shooting date and time (2023 Aug. 1 10:00), shooting location (35.6895, 139.6917), event ID (12345), face ID list (101, 102), and image tensor (224×224×3). Examples of AI output include group ID (1: Event A), editing sequence (order of photo IDs and video IDs), scene transition list (fade, slide, etc.), and story score (0.92). In subsequent processing, the editing unit automatically generates editing sequences for each group, executes video rendering processing using a parallel computation cluster with GPUs, and generates the final video file. As a technical effect, the editing unit achieves improved editing accuracy, reduced erroneous editing, and increased processing efficiency by multidimensional feature analysis integrating spatiotemporal, subject, and event information and automatic editing sequence generation, without relying on subjective human grouping or manual editing. Application fields include family album video generation, school event digest creation, corporate event promotion videos, automatic video editing for tourism customers, and short movie generation for SNS posting. Furthermore, the editing unit enables flexible editing and story generation by event or photographer unit, achieving significant improvement in accuracy and user experience compared to conventional single-image/video editing methods.

The following provides a brief explanation of the processing flow of Example of the Embodiment. Specifically, the present system realizes data processing tailored to various user states and usage environments by coordinating multiple AI modules such as a receiving unit, detection unit, extraction unit, editing unit, registration unit, and search unit. Each unit receives multimodal inputs (such as voice, image, text, biometric sensor values, etc.) and combines neural networks (e.g., CNN, RNN, Transformer), time-series analysis models, and feature extraction algorithms to automate processes such as reception method recommendation, emotion estimation, duplicate and erroneous photo detection, good photo extraction, video editing, face data registration, and search result display. Examples of AI inputs include image tensors (224×224×3), audio waveforms (16 kHz, 5 seconds), text (e.g., “I am busy now”), biometric sensor values (heart rate 80 bpm), history vectors (100 entries×8 dimensions), and GPS coordinates (35.6895, 139.6917). Examples of AI outputs include emotion labels (stress), reception method recommendation scores (Wi-Fi: 0.92, etc.), duplication scores (0.95), good photo scores (0.87), editing sequences (photo ID arrays), and search result lists (photo ID arrays). Each unit executes subsequent processing such as threshold judgment, ranking, clustering, and display parameter control based on AI outputs, thereby greatly improving user experience, operational efficiency, and data management accuracy. Applicable fields include family album management, corporate event recording, customer service in the tourism industry, school event recording, and SNS-linked automatic editing and search services. Furthermore, the present system can also implement extended functions such as coordination of multiple AI modules, distributed processing infrastructure, automatic model updating based on user feedback, anomaly detection, and trend detection, functioning as a platform with superior flexibility, scalability, and technological evolvability compared to conventional single-function systems.

Step 1: The receiving unit inputs photo or video data. The photo or video data may include formats such as JPEG, PNG, MP4, and AVI. The receiving unit uploads photos or video data taken by the user to the system. It is also possible to import data from external devices. For example, data can be received via USB connection or Wi-Fi. Step 2: The detection unit detects duplicate photos or erroneous photos from the data input by the receiving unit. Duplicate photos or erroneous photos may include identical image files, highly similar images, backlit photos, and out-of-focus photos. The detection unit uses deep learning and computer vision technologies to detect duplicate photos or erroneous photos. For example, when the same scene is photographed multiple times, the best photo is selected and other duplicate photos are eliminated. In addition, photos in which faces are dark due to backlighting or photos that are out-of-focus are also eliminated. Step 3: The extraction unit extracts good photos from the data detected by the detection unit. Good photos may include photos in which faces are clearly shown or photos with good composition. The extraction unit uses face recognition technology to extract photos in which faces are clearly shown. It is also possible to extract photos based on composition quality and image quality. Step 4: The editing unit edits a video based on the data extracted by the extraction unit. Editing may include video length, effects to be used, and transitions. The editing unit edits videos by combining videos or photos based on a duration or image specified by the user. For example, if the user specifies “create a 3-minute travel video,” photos and videos taken during the trip are combined to automatically edit a 3-minute video. If the user specifies “create an emotional atmosphere video,” emotional music and effects are added to create a video with an emotional atmosphere. Step 5: The registration unit registers faces of family members. Registration includes recognizing family member face photos uploaded by the user and registering them in a database. The registration unit uses face recognition technology to recognize family member face photos and register them in the database. Step 6: The search unit searches for desired photos or videos based on the face data registered by the registration unit. Searching includes search algorithms based on face data and methods for displaying search results. The search unit quickly searches for and displays desired photos or videos based on the registered face data. Specifically, the present system utilizes AI models (e.g., CNN, RNN, Transformer) and feature extraction algorithms at each step to process various data structures such as image tensors, face feature vectors, history vectors, and metadata. Examples of AI inputs include image tensors (224×224×3), audio waveforms (16 kHz, 5 seconds), text (e.g., “I am busy now”), face IDs, and history vectors (100 entries×8 dimensions). Examples of AI outputs include duplication scores (0.95), good photo scores (0.87), editing sequences (photo ID arrays), and search result lists (photo ID arrays). Each unit executes subsequent processing such as threshold judgment, ranking, clustering, and display parameter control based on AI outputs, thereby greatly improving user experience, operational efficiency, and data management accuracy. Furthermore, the present system can also implement extended functions such as distributed processing infrastructure, automatic model updating based on user feedback, anomaly detection, and trend detection, functioning as a platform with superior flexibility, scalability, and technological evolvability compared to conventional single-function systems.

The specific processing unit 290 sends the results of specific processing to the smart device 14. In the smart device 14, the control unit 46A causes the output device 40 to output the results of specific processing. The microphone 38B acquires voice indicating user input in response to the results of specific processing. The control unit 46A sends the voice data indicating user input acquired by the microphone 38B to the data processing device 12. In the data processing device 12, the specific processing unit 290 acquires the voice data.

The data generation model 58 is a so-called generative AI (Artificial Intelligence). An example of the data generation model 58 is a generative AI such as ChatGPT (registered trademark) (Internet search <URL: https://openai.com/blog/chatgpt>). The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

Moreover, the processing by the data processing system 10 described above is executed by the specific processing unit 290 of the data processing device 12 or the control unit 46A of the smart device 14, but it may be executed by both the specific processing unit 290 of the data processing device 12 and the control unit 46A of the smart device 14. Additionally, the specific processing unit 290 of the data processing device 12 acquires or collects necessary information for processing from the smart device 14 or external devices, and the smart device 14 acquires or collects necessary information for processing from the data processing device 12 or external devices.

Each of the plurality of elements including the aforementioned receiving unit, detection unit, extraction unit, editing unit, registration unit, and search unit is implemented by at least one of, for example, a smart device 14 and a data processing apparatus 12. For example, the receiving unit is implemented by a control unit 46A of the smart device 14 and uploads photo or video data taken by a user to the system. The detection unit is implemented by a specific processing unit 290 of the data processing apparatus 12 and detects duplicate photos or erroneous photos. The extraction unit is implemented, for example, by the specific processing unit 290 of the data processing apparatus 12 and extracts good photos. The editing unit is implemented, for example, by the specific processing unit 290 of the data processing apparatus 12 and edits videos. The registration unit is implemented, for example, by the control unit 46A of the smart device 14 and registers faces of family members. The search unit is implemented, for example, by the specific processing unit 290 of the data processing apparatus 12 and searches for desired photos or videos. The correspondence between each unit and the device or control unit is not limited to the examples described above and various modifications are possible.

### Second Embodiment

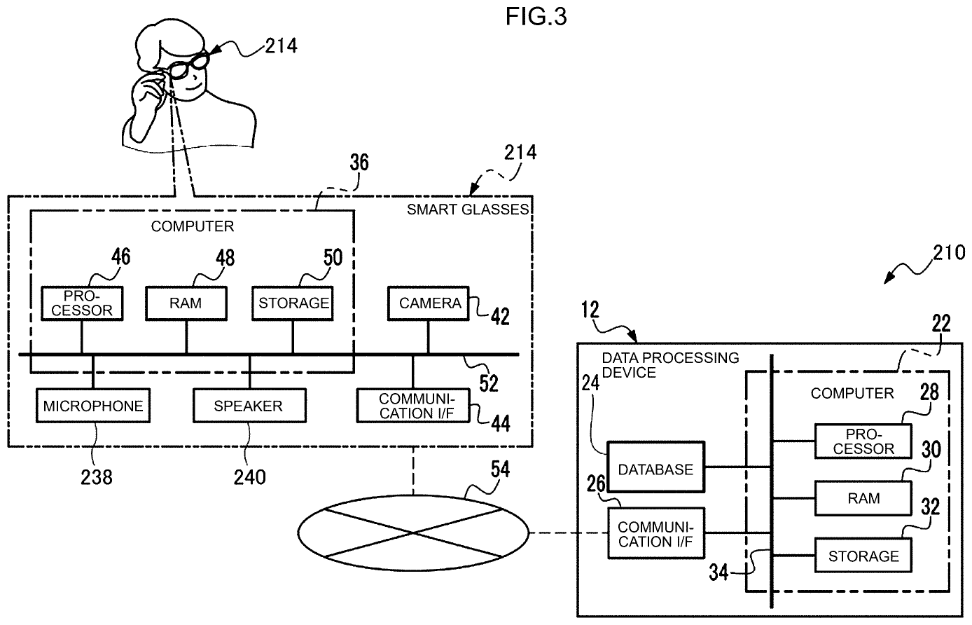

FIG. 3 shows an example configuration of a data processing system 210 according to the second embodiment.

As shown in FIG. 3, the data processing system 210 comprises a data processing device 12 and smart glasses 214. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The smart glasses 214 comprise a computer 36, a microphone 238, a speaker 240, a camera 42, and a communication I/F 44. The computer 36 comprises a processor 46, RAM 48, and storage 50. The processor 46, RAM 48, and storage 50 are connected to a bus 52. The microphone 238, speaker 240, and camera 42 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

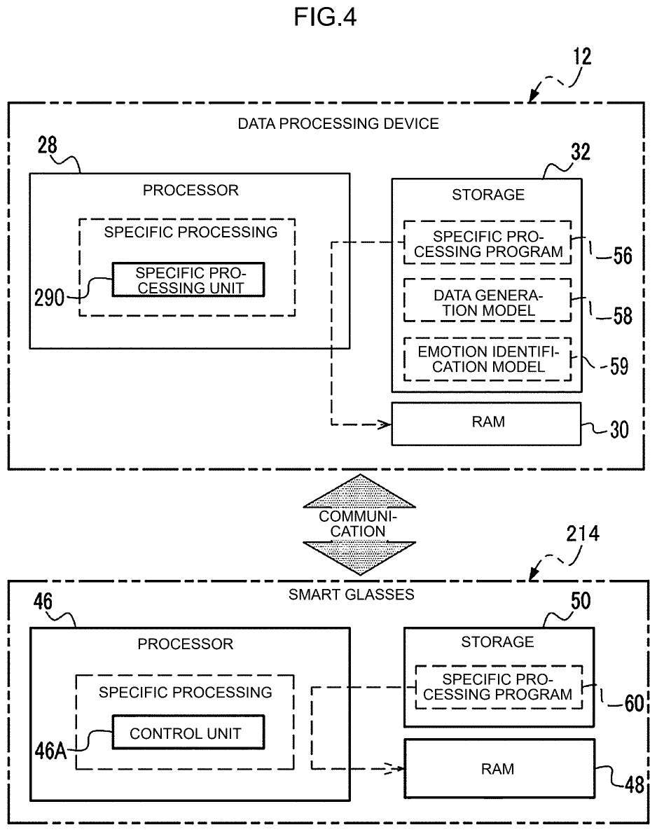

FIG. 4 shows an example of the main functions of the data processing device 12 and smart glasses 214. As shown in FIG. 4, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the smart glasses 214, specific processing is performed by the processor 46. The storage 50 stores a specific processing program 60. The processor 46 reads the specific processing program 60 from the storage 50 and executes it on the RAM 48. The specific processing is realized by the processor 46 operating as a control unit 46A according to the specific processing program 60 executed on the RAM 48. The smart glasses 214 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the smart glasses 214. In the smart glasses 214, the control unit 46A causes the speaker 240 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 210 according to the second embodiment performs the same processing as the data processing system 10 according to the first embodiment. The processing by the data processing system 210 is executed by the specific processing unit 290 of the data processing device 12 or the control unit 46A of the smart glasses 214, but it may be executed by both the specific processing unit 290 of the data processing device 12 and the control unit 46A of the smart glasses 214. Additionally, the specific processing unit 290 of the data processing device 12 acquires or collects necessary information for processing from the smart glasses 214 or external devices, and the smart glasses 214 acquires or collects necessary information for processing from the data processing device 12 or external devices.

Each of the plurality of elements including the aforementioned receiving unit, detection unit, extraction unit, editing unit, registration unit, and search unit is implemented by at least one of, for example, smart glasses 214 and a data processing apparatus 12. For example, the receiving unit is implemented by a control unit 46A of the smart glasses 214 and uploads photo or video data taken by a user to the system. The detection unit is implemented by a specific processing unit 290 of the data processing apparatus 12 and detects duplicate photos or erroneous photos. The extraction unit is implemented, for example, by the specific processing unit 290 of the data processing apparatus 12 and extracts good photos. The editing unit is implemented, for example, by the specific processing unit 290 of the data processing apparatus 12 and edits videos. The registration unit is implemented, for example, by the control unit 46A of the smart glasses 214 and registers faces of family members. The search unit is implemented, for example, by the specific processing unit 290 of the data processing apparatus 12 and searches for desired photos or videos. The correspondence between each unit and the device or control unit is not limited to the examples described above and various modifications are possible.

### Third Embodiment

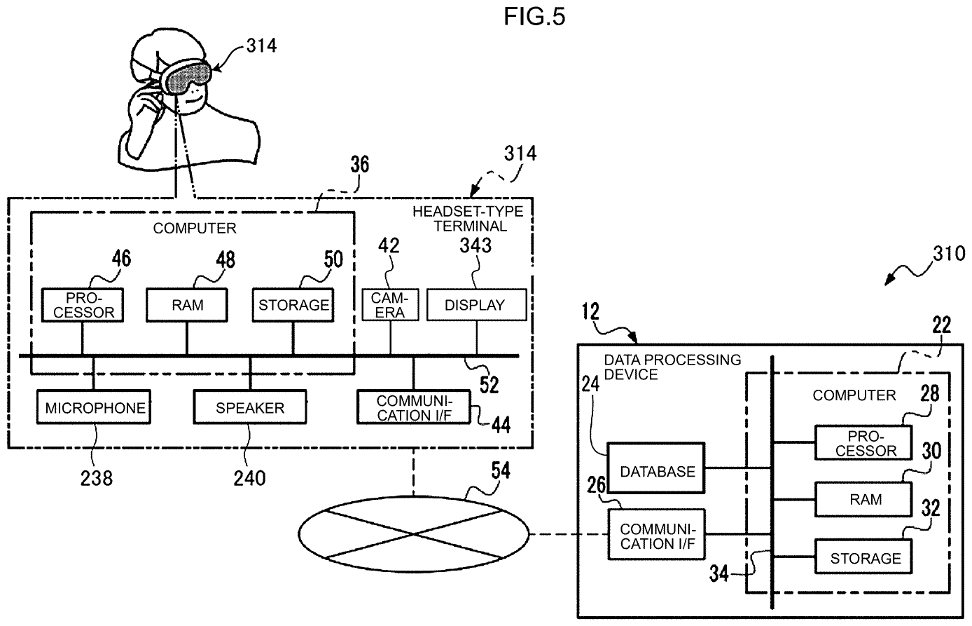

FIG. 5 shows an example configuration of a data processing system 310 according to the third embodiment.

As shown in FIG. 5, the data processing system 310 comprises a data processing device 12 and a headset-type terminal 314. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The headset-type terminal 314 comprises a computer 36, a microphone 238, a speaker 240, a camera 42, a communication I/F 44, and a display 343. The computer 36 comprises a processor 46, RAM 48, and storage 50. The processor 46, RAM 48, and storage 50 are connected to a bus 52. The microphone 238, speaker 240, camera 42, and display 343 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

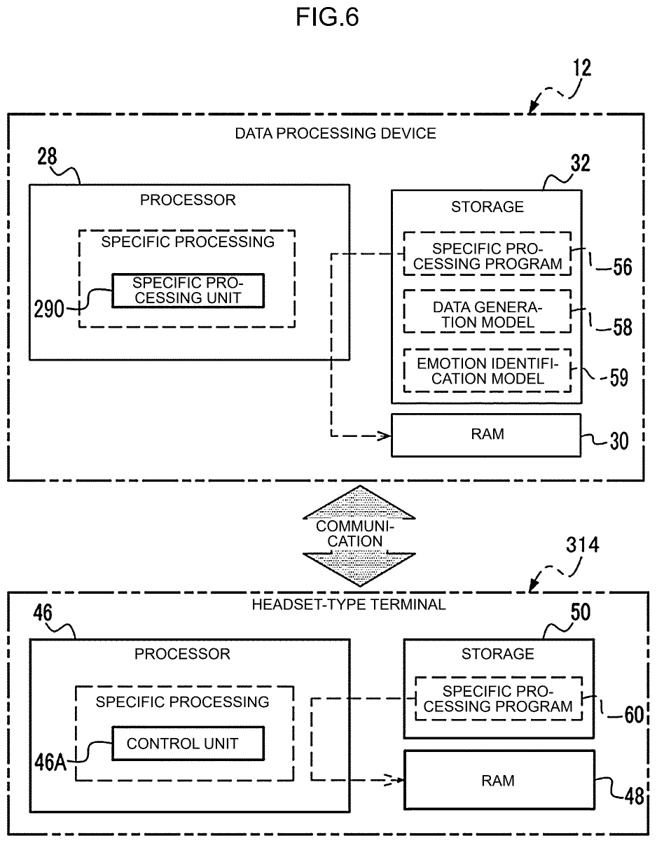

FIG. 6 shows an example of the main functions of the data processing device 12 and the headset-type terminal 314. As shown in FIG. 6, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the headset-type terminal 314, specific processing is performed by the processor 46. The storage 50 stores a specific program 60. The processor 46 reads the specific program 60 from the storage 50 and executes it on the RAM 48. The specific processing is realized by the processor 46 operating as a control unit 46A according to the specific program 60 executed on the RAM 48. The headset-type terminal 314 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the headset-type terminal 314. In the headset-type terminal 314, the control unit 46A causes the speaker 240 and the display 343 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 310 according to the third embodiment performs the same processing as the data processing system 10 according to the first embodiment. The processing by the data processing system 310 is executed by the specific processing unit 290 of the data processing device 12 or the control unit 46A of the headset-type terminal 314, but it may be executed by both the specific processing unit 290 of the data processing device 12 and the control unit 46A of the headset-type terminal 314. Additionally, the specific processing unit 290 of the data processing device 12 acquires or collects necessary information for processing from the headset-type terminal 314 or external devices, and the headset-type terminal 314 acquires or collects necessary information for processing from the data processing device 12 or external devices.

Each of the plurality of elements including the aforementioned receiving unit, detection unit, extraction unit, editing unit, registration unit, and search unit is implemented by at least one of, for example, a headset-type terminal 314 and a data processing apparatus 12. For example, the receiving unit is implemented by a control unit 46A of the headset-type terminal 314 and uploads photo or video data taken by a user to the system. The detection unit is implemented by a specific processing unit 290 of the data processing apparatus 12 and detects duplicate photos or erroneous photos. The extraction unit is implemented, for example, by the specific processing unit 290 of the data processing apparatus 12 and extracts good photos. The editing unit is implemented, for example, by the specific processing unit 290 of the data processing apparatus 12 and edits videos. The registration unit is implemented, for example, by the control unit 46A of the headset-type terminal 314 and registers faces of family members. The search unit is implemented, for example, by the specific processing unit 290 of the data processing apparatus 12 and searches for desired photos or videos. The correspondence between each unit and the device or control unit is not limited to the examples described above and various modifications are possible.

### Fourth Embodiment

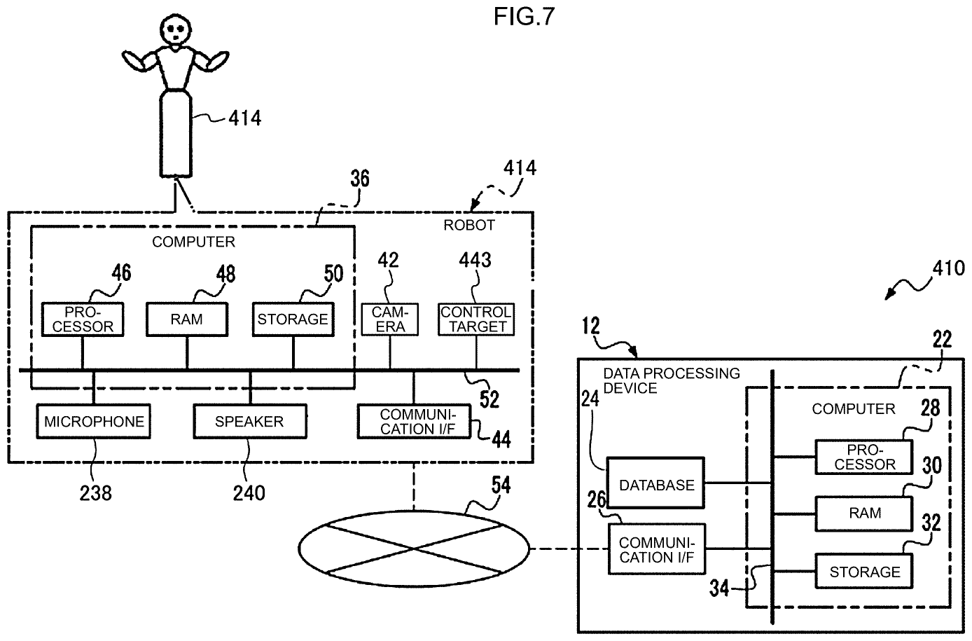

FIG. 7 shows an example configuration of a data processing system 410 according to the fourth embodiment.

As shown in FIG. 7, the data processing system 410 comprises a data processing device 12 and a robot 414. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The robot 414 comprises a computer 36, a microphone 238, a speaker 240, a camera 42, a communication I/F 44, and a control target 443. The computer 36 comprises a processor 46, RAM 48, and storage 50. The processor 46, RAM 48, and storage 50 are connected to a bus 52. The microphone 238, speaker 240, camera 42, and control target 443 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS image sensors or CCD image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

The control target 443 includes a display device, LEDs for the eyes, and motors for driving arms, hands, and feet, among others. The posture and gestures of the robot 414 are controlled by controlling the motors for the arms, hands, and feet, among others. Some emotions of the robot 414 can be expressed by controlling these motors. Additionally, the expression of the robot 414 can be expressed by controlling the lighting state of the LEDs for the eyes of the robot 414.

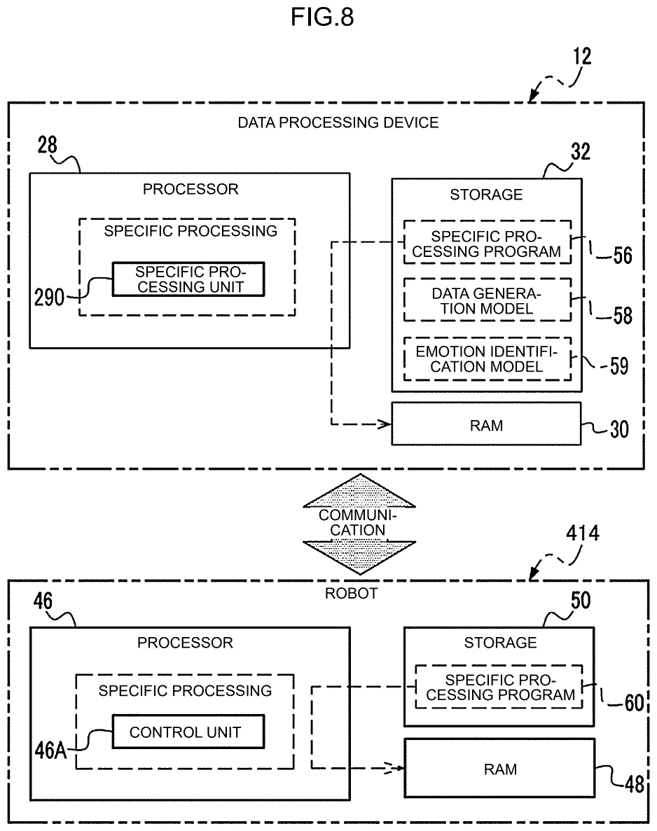

FIG. 8 shows an example of the main functions of the data processing device 12 and the robot 414. As shown in FIG. 8, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the robot 414, specific processing is performed by the processor 46. The storage 50 stores a specific program 60. The processor 46 reads the specific program 60 from the storage 50 and executes it on the RAM 48. The specific processing is realized by the processor 46 operating as a control unit 46A according to the specific program 60 executed on the RAM 48. The robot 414 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the robot 414. In the robot 414, the control unit 46A causes the speaker 240 and the control target 443 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 410 according to the fourth embodiment performs the same processing as the data processing system 10 according to the first embodiment. The processing by the data processing system 410 is executed by the specific processing unit 290 of the data processing device 12 or the control unit 46A of the robot 414, but it may be executed by both the specific processing unit 290 of the data processing device 12 and the control unit 46A of the robot 414. Additionally, the specific processing unit 290 of the data processing device 12 acquires or collects necessary information for processing from the robot 414 or external devices, and the robot 414 acquires or collects necessary information for processing from the data processing device 12 or external devices.

Each of the plurality of elements including the aforementioned receiving unit, detection unit, extraction unit, editing unit, registration unit, and search unit is implemented by at least one of, for example, a robot 414 and a data processing apparatus 12. For example, the receiving unit is implemented by a control unit 46A of the robot 414 and uploads photo or video data taken by a user to the system. The detection unit is implemented by a specific processing unit 290 of the data processing apparatus 12 and detects duplicate photos or erroneous photos. The extraction unit is implemented, for example, by the specific processing unit 290 of the data processing apparatus 12 and extracts good photos. The editing unit is implemented, for example, by the specific processing unit 290 of the data processing apparatus 12 and edits videos. The registration unit is implemented, for example, by the control unit 46A of the robot 414 and registers faces of family members. The search unit is implemented, for example, by the specific processing unit 290 of the data processing apparatus 12 and searches for desired photos or videos. The correspondence between each unit and the device or control unit is not limited to the examples described above and various modifications are possible.

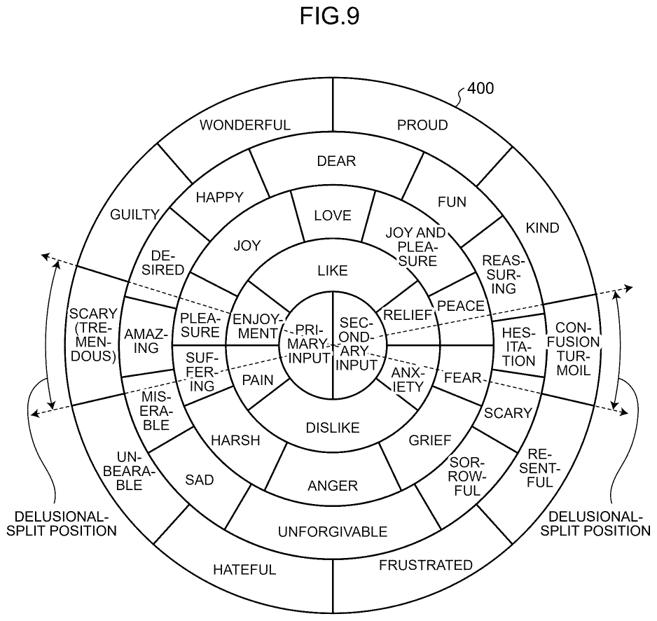

Note that the emotion identification model 59 as an emotion engine may determine the user's emotions according to a specific mapping. Specifically, the emotion identification model 59 may determine the user's emotions according to an emotion map, which is a specific mapping (see FIG. 9). Similarly, the emotion identification model 59 may determine the robot's emotions, and the specific processing unit 290 may perform specific processing using the robot's emotions.

FIG. 9 is a diagram showing an emotion map 400 where multiple emotions are mapped. In the emotion map 400, emotions are arranged concentrically radiating from the center. The closer to the center of the concentric circles, the more primitive the state of emotions is arranged. On the outer side of the concentric circles, emotions representing states and behaviors arising from mood are arranged. Emotions encompass concepts including emotional and mental states. On the left side of the concentric circles, emotions generally generated from reactions occurring in the brain are arranged. On the right side of the concentric circles, emotions generally induced by situational judgment are arranged. On the top and bottom of the concentric circles, emotions generated from reactions occurring in the brain and induced by situational judgment are arranged. Additionally, on the upper side of the concentric circles, “pleasant” emotions are arranged, and on the lower side, “unpleasant” emotions are arranged. In this way, in the emotion map 400, multiple emotions are mapped based on the structure from which emotions arise, and emotions that tend to occur simultaneously are mapped nearby.

These emotions are distributed in the 3 o'clock direction of the emotion map 400, and they usually move back and forth around reassurance and anxiety. In the right half of the emotion map 400, situational recognition takes precedence over internal sensations, giving a calm impression.

The inner side of the emotion map 400 represents the mind, and the outer side represents behavior, so the further out on the emotion map 400, the more visible (expressed in behavior) emotions become.

Here, human emotions are based on various balances like posture and blood sugar levels, and when these balances move away from the ideal, they indicate discomfort, and when they approach the ideal, they indicate comfort. In robots, cars, motorcycles, etc., emotions can be created based on various balances like posture and battery level, indicating discomfort when these balances move away from the ideal and comfort when they approach the ideal. The emotion map may be generated based on Dr. Mitsuyoshi's emotion map (Research on speech emotion recognition and brain physiological signal analysis systems related to emotions, Tokushima University, Doctoral dissertation: https://ci.nii.ac.jp/naid/500000375379). In the left half of the emotion map, emotions belonging to the domain called “reactions,” where sensations take precedence, are aligned. Additionally, in the right half of the emotion map, emotions belonging to the domain called “situations,” where situational recognition takes precedence, are aligned.

In the emotion map, two emotions that promote learning are defined. One is a negative emotion around “repentance” or “reflection” on the situation side. In other words, when a negative emotion arises in the robot, like “I never want to feel this way again” or “I don't want to be scolded again.” The other is an emotion around “desire” on the reaction side, which is positive. In other words, it is a positive feeling like “I want more” or “I want to know more.”

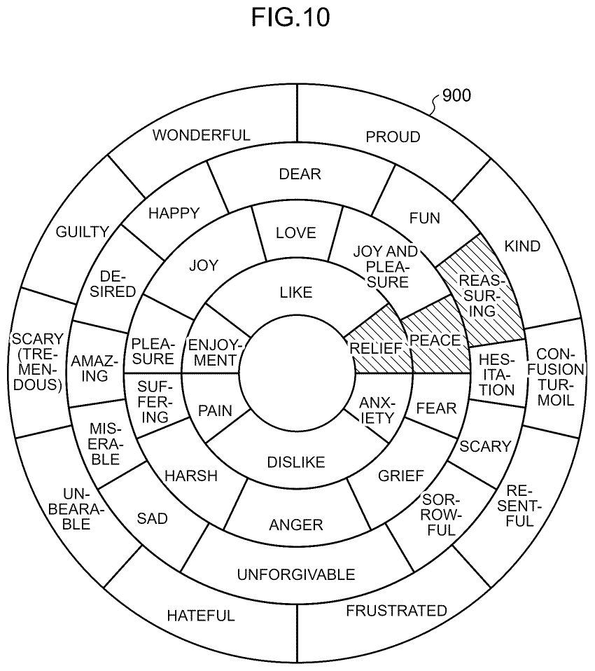

The emotion identification model 59 inputs user input into a pre-learned neural network, acquires emotion values indicating each emotion shown in the emotion map 400, and determines the user's emotions. This neural network is pre-learned based on multiple training data consisting of user input and combinations of emotion values indicating each emotion shown in the emotion map 400. Additionally, this neural network is learned so that emotions placed near each other in the emotion map 900 shown in FIG. 10 have similar values. FIG. 10 shows an example where multiple emotions like “reassured,” “calm,” and “confident” have similar emotion values.

In the above embodiments, an example form where specific processing is performed by a single computer 22 was described, but the technology disclosed herein is not limited to this, and distributed processing for specific processing by multiple computers including the computer 22 may be performed.

In the above embodiments, an example form where the specific processing program 56 is stored in the storage 32 was described, but the technology disclosed herein is not limited to this. For example, the specific processing program 56 may be stored in portable non-transitory storage media readable by a computer, such as a USB (Universal Serial Bus) memory. The specific processing program 56 stored in non-transitory storage media is installed in the computer 22 of the data processing device 12. The processor 28 executes specific processing according to the specific processing program 56.

Additionally, the specific processing program 56 may be stored in a storage device, such as a server connected to the data processing device 12 via the network 54, and downloaded and installed on the computer 22 in response to requests from the data processing device 12.

Furthermore, it is not necessary to store all of the specific processing program 56 in storage devices such as servers connected to the data processing device 12 via the network 54 or all in the storage 32, and a part of the specific processing program 56 may be stored.

Various processors, as shown next, can be used as hardware resources for executing specific processing. As processors, general-purpose processors that function as hardware resources for executing specific processing by executing software, i.e., programs, such as a CPU, can be mentioned. Additionally, as processors, dedicated electrical circuits with circuit configurations specially designed to execute specific processing, such as FPGA (Field-Programmable Gate Array), PLD (Programmable Logic Device), or ASIC (Application Specific Integrated Circuit), can be mentioned. Each processor has a built-in or connected memory, and each processor executes specific processing using the memory.

Hardware resources for executing specific processing may be composed of one of these various processors or a combination of two or more processors of the same or different types (e.g., a combination of multiple FPGAs or a combination of a CPU and FPGA). Additionally, hardware resources for executing specific processing may be a single processor.

As an example of composing with a single processor, firstly, there is a form where one or more CPUs and software are combined to constitute a single processor, which functions as hardware resources for executing specific processing. Secondly, there is a form using a processor, such as SoC (System-on-a-chip), that realizes the function of an entire system including multiple hardware resources for executing specific processing with a single IC chip. In this way, specific processing is realized using one or more of the various processors as hardware resources.

Furthermore, as a hardware structure of these various processors, more specifically, electrical circuits combined with circuit elements such as semiconductor elements can be used. Additionally, the specific processing described above is merely one example. Therefore, it goes without saying that unnecessary steps may be deleted, new steps may be added, or the order of processing may be changed within the scope not departing from the gist.

Additionally, in the examples described above, the explanation was divided into the first embodiment to the fourth embodiment, but parts or all of these embodiments may be combined. Additionally, the smart device 14, smart glasses 214, headset-type terminal 314, and robot 414 are examples, and each may be combined, or other devices may be used.

The descriptions and drawings shown above are detailed explanations of parts related to the technology disclosed herein and are merely examples of the technology disclosed herein. For example, the explanations regarding configurations, functions, actions, and effects above are explanations regarding examples of configurations, functions, actions, and effects of parts related to the technology disclosed herein. Therefore, it goes without saying that within the scope not departing from the gist of the technology disclosed herein, unnecessary parts may be deleted, new elements may be added, or replacements may be made to the descriptions and drawings shown above. Additionally, to avoid complexity and facilitate understanding of parts related to the technology disclosed herein, explanations concerning technical common knowledge and the like that do not require special explanation for enabling the implementation of the technology disclosed herein are omitted in the descriptions and drawings shown above.

All documents, patent applications, and technical standards described in this specification are incorporated by reference to the same extent as if each document, patent application, and technical standard were specifically and individually stated to be incorporated by reference in this specification.
(Supplementary Note 1)A system comprising: a receiving unit configured to input photo or video data; a detection unit configured to detect duplicate photos or erroneous photos from the data input by the receiving unit; an extraction unit configured to extract photos from the data detected by the detection unit; an editing unit configured to edit a video based on the data extracted by the extraction unit; a registration unit configured to register faces of family members; and a search unit configured to search for desired photos or videos based on the face data registered by the registration unit.
(Supplementary Note 2)The system according to Supplementary Note 1, wherein the detection unit is configured to detect duplicate photos or erroneous photos such as backlit or out-of-focus photos using image recognition technology.
(Supplementary Note 3)The system according to Supplementary Note 1, wherein the extraction unit is configured to extract photos in which faces are clearly shown or photos with a desired composition using face recognition technology.
(Supplementary Note 4)The system according to Supplementary Note 1, wherein the editing unit is configured to edit a video by combining videos or photos based on a duration or image specified by a user.
(Supplementary Note 5)The system according to Supplementary Note 1, wherein the registration unit is configured to recognize family member face photos uploaded by a user and register them in a database.
(Supplementary Note 6)The system according to Supplementary Note 1, wherein the search unit is configured to search for and display desired photos or videos based on the registered face data.
(Supplementary Note 7)The system according to Supplementary Note 1, wherein the receiving unit is configured to estimate a user's emotion and adjust the timing of receiving photo or video data based on the estimated emotion.
(Supplementary Note 8)The system according to Supplementary Note 1, wherein the receiving unit is configured to analyze a user's past data reception history and select an optimal reception method.
(Supplementary Note 9)The system according to Supplementary Note 1, wherein the receiving unit is configured to perform filtering based on the user's current project or area of interest at the time of data reception.
(Supplementary Note 10)The system according to Supplementary Note 1, wherein the receiving unit is configured to estimate a user's emotion and determine the priority of data to be received based on the estimated emotion.
(Supplementary Note 11)The system according to Supplementary Note 1, wherein the receiving unit is configured to consider a user's geographic location information at the time of data reception and preferentially receive highly relevant data.
(Supplementary Note 12)The system according to Supplementary Note 1, wherein the receiving unit is configured to analyze a user's social media activity at the time of data reception and receive relevant data.
(Supplementary Note 13)The system according to Supplementary Note 1, wherein the detection unit is configured to estimate a user's emotion and adjust the criteria for detecting duplicate photos or erroneous photos based on the estimated emotion.
(Supplementary Note 14)The system according to Supplementary Note 1, wherein the detection unit is configured to improve detection accuracy by considering interrelationships among photos or videos at the time of detection.
(Supplementary Note 15)The system according to Supplementary Note 1, wherein the detection unit is configured to perform detection by considering attribute information of the photographer of the photos or videos at the time of detection.
(Supplementary Note 16)The system according to Supplementary Note 1, wherein the extraction unit is configured to estimate a user's emotion and adjust the criteria for extracting good photos based on the estimated emotion.
(Supplementary Note 17)The system according to Supplementary Note 1, wherein the extraction unit is configured to improve extraction accuracy by considering interrelationships among photos or videos at the time of extraction.
(Supplementary Note 18)The system according to Supplementary Note 1, wherein the extraction unit is configured to perform extraction by considering attribute information of the photographer of the photos or videos at the time of extraction.
(Supplementary Note 19)The system according to Supplementary Note 1, wherein the editing unit is configured to estimate a user's emotion and adjust the video editing method based on the estimated emotion.
(Supplementary Note 20)The system according to Supplementary Note 1, wherein the editing unit is configured to improve editing accuracy by considering interrelationships among photos or videos at the time of editing.
(Supplementary Note 21)The system according to Supplementary Note 1, wherein the editing unit is configured to perform editing by considering attribute information of the photographer of the photos or videos at the time of editing.
(Supplementary Note 22)The system according to Supplementary Note 1, wherein the registration unit is configured to estimate a user's emotion and adjust the method of registering face data based on the estimated emotion.
(Supplementary Note 23)The system according to Supplementary Note 1, wherein the registration unit is configured to optimize the registration algorithm by referring to past registration data at the time of registration.
(Supplementary Note 24)The system according to Supplementary Note 1, wherein the search unit is configured to estimate a user's emotion and adjust the display method of search results based on the estimated emotion.
(Supplementary Note 25)The system according to Supplementary Note 1, wherein the search unit is configured to select an optimal search algorithm by referring to past search history at the time of searching.
(Supplementary Note 26)The system according to Supplementary Note 1, wherein the search unit is configured to estimate a user's emotion and determine the priority of search results based on the estimated emotion.
(Supplementary Note 27)The system according to Supplementary Note 1, wherein the search unit is configured to provide optimal search results by considering a user's device information at the time of searching.

What is claimed is:

1. A system comprising:
a communication interface configured to communicate with a client terminal via a network;
a processor;
a random-access memory;
a storage storing a data generation model obtained by deep learning on a neural network and an emotion identification model;
a database; and
circuitry configured to:
receive, from the client terminal via the communication interface, photo or video data, the photo or video data being stored in the random-access memory as image tensors;
extract, using an image classification model comprising a convolutional neural network, feature vectors from the image tensors, compute duplicate scores by calculating a similarity metric between the feature vectors, and detect duplicate photos or erroneous photos from the photo or video data based on the duplicate scores;
extract, using a face recognition model, photos in which faces satisfy a clarity threshold from the photo or video data from which the duplicate photos or the erroneous photos have been detected;
edit a video by determining an editing sequence based on metadata of the extracted photos and a user instruction vectorized by a text encoder, and generating a video file according to the editing sequence;
register, in the database, face feature vectors extracted from face photos received from the client terminal, together with metadata comprising at least a face identifier and an age estimation; and
search the database, using an approximate nearest neighbor search on the face feature vectors, for photos or videos matching a search query received from the client terminal, and transmit search results to the client terminal via the communication interface.

2. The system according to claim 1,
wherein the image classification model further comprises a self-attention mechanism, and wherein the circuitry is configured to extract the feature vectors with 512 or more dimensions from each image or video frame.

3. The system according to claim 1,
wherein the similarity metric comprises at least one of a cosine similarity or a Euclidean distance between the feature vectors.

4. The system according to claim 1,
wherein the circuitry is further configured to group the image tensors using a clustering algorithm, calculate a quality score for each image within each group, and retain only an image having a highest quality score within each group.

5. The system according to claim 1,
wherein the circuitry is further configured to detect erroneous photos by extracting face regions using a face detection model, quantifying a backlight degree and an out-of-focus degree based on a brightness distribution and edge information of the face regions, and eliminating photos exceeding an erroneous photo threshold.

6. The system according to claim 1,
wherein the face recognition model comprises at least one of a ResNet-based model or a Transformer-based model, and wherein the circuitry is configured to calculate, for each face region, a face clarity score based on edge strength, noise amount, and landmark detection accuracy.

7. The system according to claim 1,
wherein the circuitry is further configured to calculate a composition score for each photo based on at least one of a rule-of-thirds score, a subject centering metric, or a color balance metric, and to extract photos based on a weighted synthesis of the face clarity threshold and the composition score.

8. The system according to claim 1,
wherein the editing sequence is determined using at least one of reinforcement learning or beam search to select photo and video clips that fit within a user-specified video length while maximizing scene flow.

9. The system according to claim 1,
wherein the circuitry is further configured to automatically apply at least one of a transition effect, background music selection, or a color correction effect to the video file based on a theme specified in the user instruction.

10. The system according to claim 1,
wherein the face feature vectors comprise 128-dimensional or 512-dimensional vectors, and wherein the circuitry is further configured to estimate an age of a face in each face photo using an age estimation convolutional neural network and to store the estimated age as part of the metadata in the database.

11. The system according to claim 1,
wherein the approximate nearest neighbor search uses at least one of an Annoy index or a FAISS index to search the face feature vectors in the database.

12. The system according to claim 1,
wherein the circuitry is further configured to vectorize a natural language search query received from the client terminal using a text encoder, combine the vectorized query with face identifier, age, and shooting date metadata, and generate search conditions for the approximate nearest neighbor search.

13. The system according to claim 1,
wherein the circuitry is further configured to estimate a user emotion by applying the emotion identification model to at least one of voice data, a face image, text input, or biometric sensor data received from the client terminal, and to dynamically adjust a detection threshold for the duplicate scores based on the estimated user emotion.

14. The system according to claim 1,
wherein the circuitry is further configured to estimate a user emotion by applying the emotion identification model to at least one of voice data, a face image, text input, or biometric sensor data received from the client terminal, and to dynamically adjust an extraction threshold for a good photo score based on the estimated user emotion.

15. The system according to claim 1,
wherein the circuitry is further configured to group the photo or video data by considering interrelationships comprising at least one of a shooting date and time, a shooting location based on GPS coordinates, or a subject commonality, and to adjust the duplicate scores within each group based on the interrelationships.

16. The system according to claim 1,
wherein the circuitry is further configured to analyze a past data reception history of a user and select an optimal data reception method for the photo or video data based on a reception method recommendation score calculated from the past data reception history.

17. The system according to claim 1,
wherein the circuitry is further configured to receive geographic location information from the client terminal and to adjust a reception priority of the photo or video data based on a spatial distance between a current location of the client terminal and a shooting location of the photo or video data.

18. A system comprising:
a communication interface configured to communicate, via a packet-switched network conforming to at least one of a 5G, Wi-Fi, or Bluetooth communication standard, with a client terminal comprising a camera having a CMOS image sensor, a touch panel, a microphone, a speaker, and a display;
a processor;
a random-access memory;
a storage storing a data generation model obtained by deep learning on a neural network, and an emotion identification model;
a database storing face feature vectors, each face feature vector associated with a face identifier and an age estimation; and
circuitry configured to:
receive, from the client terminal via the communication interface, photo or video data comprising at least one of JPEG, PNG, MP4, or AVI format data;
store the photo or video data in the random-access memory as image tensors comprising at least one of three-dimensional RGB tensors or four-dimensional spatiotemporal tensors;
extract, using an image classification model comprising a convolutional neural network and a self-attention mechanism, feature vectors of 512 or more dimensions from the image tensors, compute duplicate scores by calculating at least one of cosine similarity or Euclidean distance between the feature vectors, and detect duplicate photos or erroneous photos based on the duplicate scores;
extract, using a face recognition model comprising at least one of a ResNet-based model or a Transformer-based model, photos satisfying a good photo score threshold from the photo or video data, the good photo score being computed based on a face clarity score and a composition score;
edit a video by vectorizing a user instruction using a text encoder, combining the vectorized user instruction with metadata of the extracted photos to determine an editing sequence using at least one of reinforcement learning or beam search, and generating a video file;
register, in the database, face feature vectors extracted from face photos received from the client terminal using a face detection model and a face recognition model, together with an age estimation generated by an age estimation convolutional neural network; and
search the database by performing an approximate nearest neighbor search, using at least one of an Annoy index or a FAISS index, on the face feature vectors to identify photos or videos matching a search query received from the client terminal, and transmit the identified photos or videos to the client terminal via the communication interface.

19. The system according to claim 18,
wherein the data generation model comprises at least one of a text generation AI, an image generation AI, or a multimodal generation AI, and wherein the data generation model is a fine-tuned model configured to output inference results from prompts without instructions.

20. A method performed by circuitry of a data processing system comprising a processor, a random-access memory, a storage storing a data generation model obtained by deep learning on a neural network and an emotion identification model, a database, and a communication interface, the method comprising:
receiving, from a client terminal via the communication interface, photo or video data, and storing the photo or video data in the random-access memory as image tensors;
extracting, using an image classification model comprising a convolutional neural network, feature vectors from the image tensors, computing duplicate scores by calculating a similarity metric between the feature vectors, and detecting duplicate photos or erroneous photos based on the duplicate scores;
extracting, using a face recognition model, photos in which faces satisfy a clarity threshold from the photo or video data from which the duplicate photos or the erroneous photos have been detected;
editing a video by determining an editing sequence based on metadata of the extracted photos and a user instruction vectorized by a text encoder, and generating a video file according to the editing sequence;
registering, in the database, face feature vectors extracted from face photos received from the client terminal, together with metadata comprising at least a face identifier and an age estimation; and
searching the database, using an approximate nearest neighbor search on the face feature vectors, for photos or videos matching a search query received from the client terminal, and transmitting search results to the client terminal via the communication interface.
